(19) United States
(12) Patent Application Publication
(10) Pub. No.: US 2026/0330898 A1
(43) Pub. Date: Oct. 22, 2026

(54) Vehicle Fault Diagnosis Method and Apparatus

(71) Applicant: HUAWEI TECHNOLOGIES CO., LTD., Shenzhen (CN)

(72) Inventor: Kang Cheng, Shenzhen (CN)

(73) Assignee: HUAWEI TECHNOLOGIES CO., LTD., Shenzhen (CN)

(21) Appl. No.: 19/703,956

(22) Filed: Jun. 10, 2026

Related U.S. Application Data
(63) Continuation of application No. PCT/CN2024/127410, filed on Oct. 25, 2024.

(30) Foreign Application Priority Data
Dec. 11, 2023 (CN) 202311692701.1

(51) Int. Cl. G07C 5/08; G06N 3/0475

(52) U.S. Cl. CPC G07C 5/0816; G06N 3/0475; G07C 5/0808

(57) ABSTRACT

A method includes: obtaining first fault description data of a first vehicle, and then inputting the first fault description data of the first vehicle into a fault diagnosis model to obtain a first diagnosis result, where the fault diagnosis model is used to describe a correspondence between fault description data of a vehicle and a diagnosis result, and the first diagnosis result indicates a fault diagnosis agent module to perform a fault diagnosis operation corresponding to the first diagnosis result.

### CROSS-REFERENCE TO RELATED APPLICATIONS

This is a continuation of International Patent Application No. PCT/CN2024/127410, filed on Oct. 25, 2024, which claims priority to Chinese Patent Application No. 202311692701.1, filed on Dec. 11, 2023, which are both incorporated by reference.

### TECHNICAL FIELD

This disclosure relates to the field of internet of vehicles technologies, and in particular, to a vehicle fault diagnosis method and apparatus.

### BACKGROUND

With rapid development of new energy technologies, electric vehicles have also developed rapidly, and have begun to be launched to the market on a large scale, attracting widespread attention from users. After-sales assurance and maintenance of the electric vehicles are important factors for users to determine whether to purchase electric vehicles, and are also an important part of user experience. In addition, an electric vehicle is a collection of a plurality of intelligent components, and software of the plurality of intelligent components is continuously and iteratively updated. Although iterative updates of the software of the intelligent components help continuously provide new features during the lifecycle of the vehicle, they also inevitably bring faults to the vehicle.

Some solutions are provided in the industry for handling faults of electric vehicles. However, in these solutions, a user needs to drive the electric vehicle to an automobile sales service shop for manual detection and locating of the vehicle fault and fault repair, or the user needs to dial a customer service phone number, describe fault symptoms of the vehicle to a customer service representative, and wait for a solution fed back by the customer service representative. Because these solutions rely on manual operations, vehicle fault diagnosis is time-consuming, resulting in low efficiency of vehicle fault locating and slow response to fault diagnosis.

### SUMMARY

This disclosure provides a vehicle fault diagnosis method and apparatus, to improve efficiency of vehicle fault diagnosis.

According to a first aspect, this disclosure provides a vehicle fault diagnosis method. The method may be applied to the field of electric vehicles, the field of operation and maintenance, the field of any connected vehicles, or the like. In some instances, the method may be performed by a vehicle fault diagnosis apparatus or a component (for example, a chip, a chip system, or a circuit) that can support the vehicle fault diagnosis apparatus in implementing a function for the method. For example, the vehicle fault diagnosis apparatus may be a functional module (for example, a first functional module) configured with a fault diagnosis model, or a device (for example, a first compute device) configured with the fault diagnosis model, or may be a fault diagnosis agent module configured with the fault diagnosis model, or may be an integrated module (which may alternatively be referred to as an integrated unit) of the first functional module (or the first compute device) and the fault diagnosis agent module, or may be another device that has a vehicle fault diagnosis function or a functional element (for example, a plug-in, a component, or a chip) disposed in the another device that has the vehicle fault diagnosis function. In some instances, for example, the vehicle fault diagnosis apparatus performs the vehicle fault diagnosis method. In the method, the vehicle fault diagnosis apparatus may first obtain first fault description data of a first vehicle, and then the vehicle fault diagnosis apparatus may input the first fault description data into the fault diagnosis model to obtain a first diagnosis result, where the fault diagnosis model may be used to describe a correspondence between fault description data of a vehicle and a diagnosis result, and the first diagnosis result may indicate the fault diagnosis agent module to perform a fault diagnosis operation corresponding to the first diagnosis result.

In this method, the first fault description data of the first vehicle (which may alternatively be understood as a fault symptom description of the vehicle) is analyzed by using the fault diagnosis model, so that a corresponding diagnosis result (for example, the first diagnosis result) can be obtained in time and effectively. In this way, manual vehicle fault diagnosis can be replaced. This helps reduce duration of vehicle fault diagnosis, thereby improving efficiency of vehicle fault diagnosis.

In a possible design, the method further includes: The vehicle fault diagnosis apparatus may generate a first fault handling report based on the first diagnosis result, and then the vehicle fault diagnosis apparatus may feed back the first fault handling report to the first vehicle.

In the foregoing design, when the vehicle fault diagnosis apparatus is the integrated module of the first functional module (or the first compute device) and the fault diagnosis agent module, after obtaining the first diagnosis result, the vehicle fault diagnosis apparatus can generate the first fault handling report of the first vehicle based on the first diagnosis result, and can feed back the first fault handling report of the first vehicle to the first vehicle in time, so that a user of the first vehicle learns of a fault condition of the first vehicle in time. In this way, the user of the first vehicle can take a corresponding fault handling measure in a targeted manner.

In a possible design, the method further includes: The vehicle fault diagnosis apparatus may send the first diagnosis result to the fault diagnosis agent module, where the first diagnosis result is used to generate a first fault handling report.

In the foregoing design, when the vehicle fault diagnosis apparatus is the first functional module, the vehicle fault diagnosis apparatus can send the first diagnosis result to the fault diagnosis agent module in time, so that the fault diagnosis agent module accurately performs a corresponding diagnosis operation based on the first diagnosis result. For example, the fault diagnosis agent module may generate the first fault handling report based on the first diagnosis result, or the fault diagnosis agent module may send corresponding information to a corresponding fault diagnosis module.

In a possible design, that the vehicle fault diagnosis apparatus generates the first fault handling report based on the first diagnosis result includes: When the first diagnosis result includes information about a first fault diagnosis module, the vehicle fault diagnosis apparatus may send first information to the first fault diagnosis module, where the first information may include information about the first vehicle (for example, a vehicle identifier, a vehicle name, or a vehicle model and a vehicle series of the first vehicle, or time (or a time period) at (or in) which the first vehicle has a fault), and the first information indicates to perform fault diagnosis on the first vehicle; and then, the vehicle fault diagnosis apparatus may obtain a second diagnosis result from the first fault diagnosis module, and next, the vehicle fault diagnosis apparatus may generate the first fault handling report based on the second diagnosis result.

In the foregoing design, when the vehicle fault diagnosis apparatus is the integrated module of the first functional module (or the first compute device) and the fault diagnosis agent module, the vehicle fault diagnosis apparatus can send the first information to the first fault diagnosis module when the first diagnosis result includes the information about the first fault diagnosis module, to further determine (or locate, or identify, or perceive) the fault of the first vehicle via the first fault diagnosis module. This effectively locates the vehicle fault. In this way, in the method, the fault diagnosis agent module is used, so that the fault diagnosis model can have a capability of invoking a corresponding fault diagnosis module. This can implement a fully automatic operation of vehicle fault analysis, vehicle fault diagnosis, and vehicle fault determining, and help greatly improve efficiency of vehicle fault diagnosis (or vehicle fault locating or vehicle fault detection).

In a possible design, the first fault description data may be obtained by performing format conversion on second fault description data of the first vehicle, where the second fault description data may be obtained through user input.

In a possible design, a data type of the second fault description data may include at least one of the following: a voice, a text, a picture, or a recording.

In the foregoing design, the second fault description data of the first vehicle can be obtained through human-machine interaction. In this way, the user can submit the fault symptom description of the first vehicle in time and accurately through an interaction interface. In addition, format conversion is performed on the second fault description data of the first vehicle, to obtain fault description data that satisfies an input data format (which may alternatively be understood as an input data type) that may be required by the fault diagnosis model. Therefore, the fault diagnosis model can perceive input data of different data types (for example, the user can simultaneously submit fault symptom descriptions of different data types (for example, the user can simultaneously submit any two or more of a fault symptom described by voice, the fault symptom described in text, a picture including the fault symptom, or a recording (or a sound) including the fault symptom)).

In a possible design, the fault diagnosis model may be obtained by training a generative artificial intelligence (AI) model (for example, a Pangu model) based on a fault training sample, where the fault training sample may include fault description data and a fault cause (a part of content included in a diagnosis result). In some instances, the fault training sample may further include information about the fault diagnosis module (for example, whether the fault diagnosis module needs to be used for confirmation (or re-diagnosis) or attribute information (for example, an identifier, a name, or an API) of the fault diagnosis module).

In the foregoing design, vehicle fault diagnosis knowledge (for example, related content included in the fault training sample) is learned through a learning capability of the generative AI model, so that the fault diagnosis model used to determine the vehicle fault can be obtained. For example, the vehicle fault can be analyzed through a multimodal understanding capability of the fault diagnosis model. In this way, manual vehicle fault diagnosis can be replaced. This helps reduce the duration of vehicle fault diagnosis, thereby improving efficiency of vehicle fault diagnosis.

In a possible design, the generative AI model may be a large multimodal model.

In the foregoing design, input data of different data types can be perceived through a multimodal understanding capability of the large multimodal model, so that the fault symptom description submitted by the user can be comprehensively understood, to determine the vehicle fault.

In a possible design, the first fault handling report may include at least one of the following: a fault cause, a fault level, or a handling scheme corresponding to the fault cause.

In the foregoing design, the first fault handling report includes one or more of the fault cause, the fault level, or the handling scheme corresponding to the fault cause, so that the user of the vehicle can learn of the fault condition of the vehicle in time. In this way, the user of the first vehicle can take the corresponding fault handling measure in time.

According to a second aspect, this disclosure provides a vehicle fault diagnosis method. The method may be applied to the field of electric vehicles, the field of operation and maintenance, the field of any connected vehicles, or the like. In some instances, the method may be performed by a vehicle fault diagnosis apparatus or a component (for example, a chip, a chip system, or a circuit) that can support the vehicle fault diagnosis apparatus in implementing a function for the method. For example, the vehicle fault diagnosis apparatus may be a fault diagnosis agent module, or may be a fault diagnosis agent module configured with a fault diagnosis model, or may be an integrated module (which may alternatively be referred to as an integrated unit) of a first functional module (or a first compute device) and the fault diagnosis agent module, or may be another device that has a vehicle fault diagnosis function or a functional element (for example, a plug-in, a component, or a chip) disposed in the another device that has the vehicle fault diagnosis function. In some instances, for example, the vehicle fault diagnosis apparatus performs the vehicle fault diagnosis method. In the method, the vehicle fault diagnosis apparatus may first receive a first diagnosis result, where the first diagnosis result is associated with first fault description data of a first vehicle and the fault diagnosis model, the fault diagnosis model may be used to describe a correspondence between fault description data of a vehicle and a diagnosis result, and the first diagnosis result may indicate the fault diagnosis agent module to perform a fault diagnosis operation corresponding to the first diagnosis result; and then the vehicle fault diagnosis apparatus may perform, based on the first diagnosis result, the fault diagnosis operation corresponding to the first diagnosis result.

For technical effect that can be achieved in the second aspect, refer to the technical effect that can be achieved in the first aspect. Details are not described herein again.

In a possible design, that the vehicle fault diagnosis apparatus performs, based on the first diagnosis result, the fault diagnosis operation corresponding to the first diagnosis result includes: The vehicle fault diagnosis apparatus may generate a first fault handling report based on the first diagnosis result.

In the foregoing design, the first fault handling report of the first vehicle can be effectively generated based on the first diagnosis result.

In a possible design, when the first diagnosis result includes information about a first fault diagnosis module, the method further includes: The vehicle fault diagnosis apparatus may send first information to the first fault diagnosis module, where the first information may include information about the first vehicle, and the first information may indicate to perform fault diagnosis on the first vehicle; and then the vehicle fault diagnosis apparatus may obtain a second diagnosis result from the first fault diagnosis module, where the second diagnosis result may be used to generate the first fault handling report.

In the foregoing design, the vehicle fault diagnosis apparatus sends the first information to the first fault diagnosis module, to further determine a fault of the first vehicle via the first fault diagnosis module. This effectively locates the vehicle fault. In this way, in the method, the fault diagnosis agent module is used, so that the fault diagnosis model can have a capability of invoking a corresponding fault diagnosis module. This can implement a fully automatic operation of vehicle fault analysis, vehicle fault diagnosis, and vehicle fault determining, and help greatly improve efficiency of vehicle fault diagnosis (or vehicle fault locating or vehicle fault detection).

In a possible design, the method further includes: The vehicle fault diagnosis apparatus may feed back the first fault handling report to the first vehicle.

In the foregoing design, the first fault handling report of the first vehicle is fed back to the first vehicle, so that a user of the first vehicle can learn of a fault condition of the first vehicle in time. In this way, the user of the first vehicle can take a corresponding fault handling measure in time.

In a possible design, the first fault description data may be obtained by performing format conversion on second fault description data of the first vehicle, where the second fault description data may be obtained through user input.

For technical effect that can be achieved in the foregoing design, refer to the technical effect of the corresponding design in the first aspect. Details are not described herein again.

In a possible design, a data type of the second fault description data may include at least one of the following: a voice, a text, a picture, or a recording.

In a possible design, the fault diagnosis model may be obtained by training a generative AI model (for example, a Pangu model) based on a fault training sample, where the fault training sample may include fault description data and a fault cause (a part of content included in a diagnosis result). In some instances, the fault training sample may further include information about the fault diagnosis module (for example, whether the fault diagnosis module needs to be used for confirmation (or re-diagnosis) or attribute information (for example, an identifier, a name, or an application programming interface (API)) of the fault diagnosis module).

For technical effect that can be achieved in the foregoing design, refer to the technical effect of the corresponding design in the first aspect. Details are not described herein again.

In a possible design, the generative AI model may be a large multimodal model.

For technical effect that can be achieved in the foregoing design, refer to the technical effect of the corresponding design in the first aspect. Details are not described herein again.

In a possible design, the first fault handling report may include at least one of the following: a fault cause, a fault level, or a handling scheme corresponding to the fault cause.

For technical effect that can be achieved in the foregoing design, refer to the technical effect of the corresponding design in the first aspect. Details are not described herein again.

According to a third aspect, this disclosure provides a possible vehicle fault diagnosis apparatus. In an example, the vehicle fault diagnosis apparatus is a vehicle fault diagnosis apparatus (for example, a first functional module or an integrated module of the first functional module and a fault diagnosis agent module) that has a function for implementing the method according to the first aspect, or may be an element (for example, a plug-in, a component, or a chip) that is disposed in the vehicle fault diagnosis apparatus and that has the function for implementing the method according to the first aspect, or may be any other device that has the function for implementing the method according to the first aspect, or may be an element that is disposed in any other device and that has the function for implementing the method according to the first aspect. In another example, the vehicle fault diagnosis apparatus is a vehicle fault diagnosis apparatus (for example, a fault diagnosis agent module or an integrated module of a first functional module and the fault diagnosis agent module) that has a function for implementing the method according to the second aspect, or may be an element (for example, a plug-in, a component, or a chip) that is disposed in the vehicle fault diagnosis apparatus and that has the function for implementing the method according to the second aspect, or may be any other device that has the function for implementing the method according to the second aspect, or may be an element that is disposed in any other device and that has the function for implementing the method according to the second aspect.

For example, when the vehicle fault diagnosis apparatus is a chip disposed in the vehicle fault diagnosis apparatus, the vehicle fault diagnosis apparatus may include a transceiver and a processor, and does not include a memory. The transceiver exists in a form of an input/output interface, and the input/output interface is used by the chip to implement receiving and sending of a vehicle fault diagnosis apparatus. The input/output interface may include an input interface and/or an output interface. The processor is configured to: read and execute a corresponding computer program or corresponding instructions, so that a corresponding function of the vehicle fault diagnosis apparatus is implemented.

When the vehicle fault diagnosis apparatus is configured to implement any possible method according to the first aspect, for beneficial effect, refer to corresponding descriptions in the first aspect. Details are not described herein again. The vehicle fault diagnosis apparatus has the function of implementing the method according to the first aspect. The function may be implemented by hardware, or may be implemented by hardware executing corresponding software. The hardware or the software includes one or more modules corresponding to the foregoing function. In a possible design, the vehicle fault diagnosis apparatus includes a communication module (which may alternatively be referred to as a transceiver module, a transceiver unit, or a communication unit, and is configured to: send and receive data) and a processing module. The communication module is configured to obtain first fault description data of a first vehicle. The processing module is configured to input the first fault description data into a fault diagnosis model to obtain a first diagnosis result. The fault diagnosis model may be used to describe a correspondence between fault description data of a vehicle and a diagnosis result, and the first diagnosis result indicates the fault diagnosis agent module to perform a fault diagnosis operation corresponding to the first diagnosis result. These modules may perform corresponding functions in any possible design of the first aspect. For details, refer to detailed descriptions of corresponding functions of the first functional module (or the integrated module of the first functional module and the fault diagnosis agent module) in the method examples. Details are not described herein again.

When the vehicle fault diagnosis apparatus is configured to implement any possible method according to the second aspect, for beneficial effect, refer to corresponding descriptions in the second aspect. Details are not described herein again. The vehicle fault diagnosis apparatus has the function of implementing the method according to the second aspect. The function may be implemented by hardware, or may be implemented by hardware executing corresponding software. The hardware or the software includes one or more modules corresponding to the foregoing function. In a possible design, the vehicle fault diagnosis apparatus includes a communication module and a processing module. The communication module is configured to receive a first diagnosis result. The first diagnosis result is associated with first fault description data of a first vehicle and a fault diagnosis model, the fault diagnosis model may be used to describe a correspondence between fault description data of a vehicle and a diagnosis result, and the first diagnosis result may indicate the fault diagnosis agent module to perform a fault diagnosis operation corresponding to the first diagnosis result. The processing module is configured to perform, based on the first diagnosis result, the fault diagnosis operation corresponding to the first diagnosis result. These modules may perform corresponding functions in any possible design of the second aspect. For details, refer to detailed descriptions of corresponding functions of the fault diagnosis agent module (or the integrated module of the first functional module and the fault diagnosis agent module) in the method examples. Details are not described herein again.

According to a fourth aspect, this disclosure provides a possible vehicle fault diagnosis apparatus. The vehicle fault diagnosis apparatus may be an apparatus (for example, a first functional module, a fault diagnosis agent module, or an integrated module of the first functional module and the fault diagnosis agent module) configured to perform the vehicle fault diagnosis method provided in this disclosure, or may be a device (for example, a data analysis and processing system) that includes the vehicle fault diagnosis apparatus for performing the method provided in this disclosure, or may be a device that has a function for implementing the vehicle fault diagnosis method. The vehicle fault diagnosis apparatus may include a transceiver and a processor. In some instances, the vehicle fault diagnosis apparatus may further include a memory. The memory is configured to store a computer program or instructions. The processor is coupled to the memory and the transceiver. When the processor executes the computer program or the instructions, the vehicle fault diagnosis apparatus is enabled to perform the method according to any possible design of the first aspect or the method according to any possible design of the second aspect. In an example, the transceiver may be a transceiver apparatus integrated with data receiving and sending functions. In another example, the transceiver may alternatively include a transmitter and a receiver. The transmitter is configured to send data, and the receiver is configured to receive data.

According to a fifth aspect, this disclosure provides a possible vehicle fault diagnosis system. The vehicle fault diagnosis system includes the vehicle fault diagnosis apparatus in the first aspect and/or the vehicle fault diagnosis apparatus in the second aspect. The vehicle fault diagnosis apparatus in the first aspect is configured to perform the method according to any possible design of the first aspect. The vehicle fault diagnosis apparatus in the second aspect is configured to perform the method according to any possible design of the second aspect. For example, there may be one or more vehicle fault diagnosis apparatuses included in the vehicle fault diagnosis system. This is not limited in this disclosure. In some instances, the vehicle fault diagnosis system may further include at least one of the following: a data storage system, a data preprocessing system, or a diagnosis result feedback system. The data storage system may be configured to store at least one of the following: first fault description data, second fault description data, a first diagnosis result, a second diagnosis result, or a first fault handling report. The data preprocessing system may be configured to preprocess the second fault description data of a first vehicle. The diagnosis result feedback system may be configured to feed back the first fault handling report to the first vehicle (or a user of the first vehicle or a manufacturer corresponding to the first vehicle). In addition, the vehicle fault diagnosis system may be further configured to provide a fault description interface. The fault description interface may be used to prompt the user of the first vehicle to input a corresponding fault diagnosis requirement. For example, the fault diagnosis requirement may include the second fault description data of the first vehicle.

According to a sixth aspect, this disclosure provides a computer program product. The computer program product includes a computer program or instructions. When the computer program or the instructions are run on a computer, the computer is enabled to perform the method according to any possible design of the first aspect or the method according to any possible design of the second aspect.

According to a seventh aspect, this disclosure provides a computer-readable storage medium. The computer-readable storage medium stores a computer program or instructions. When the computer program or the instructions are executed by a computer, the computer is enabled to perform the method according to any possible design of the first aspect or the method according to any possible design of the second aspect.

According to an eighth aspect, this disclosure provides a chip. The chip may include a processor, and may further include a memory (or the chip is coupled to the memory). The chip executes program instructions in the memory, to perform the method according to any possible design of the first aspect or the method according to any possible design of the second aspect. “Coupling” means that two components are directly or indirectly combined with each other. For example, coupling may mean that the two components are electrically connected to each other.

According to a ninth aspect, this disclosure further provides a chip system. The chip system includes a processor configured to support a computer apparatus in implementing the method according to any possible design of the first aspect or the method according to any possible design of the second aspect. In a possible design, the chip system further includes a memory. The memory is configured to store a program and data that are for the computer apparatus. The chip system may include a chip, or may include the chip and another discrete device.

In this disclosure, the implementations provided in the foregoing aspects may be further combined to provide more implementations.

### BRIEF DESCRIPTION OF DRAWINGS

FIG. 1 shows an example of a diagram of a possible application scenario according to an embodiment of this disclosure.

FIG. 2 shows an example of a diagram of a functional module structure of a vehicle fault diagnosis system according to an embodiment of this disclosure.

FIG. 3 shows an example of a schematic flowchart of a vehicle fault diagnosis method according to an embodiment of this disclosure.

FIG. 4 shows an example of a diagram of a fault description interface according to an embodiment of this disclosure.

FIG. 5 shows an example of a diagram of training a fault diagnosis model according to an embodiment of this disclosure.

FIG. 6 shows an example of a diagram of a minimal problem fault tree for an audio system exception according to an embodiment of this disclosure.

FIG. 7 shows an example of a schematic flowchart of another vehicle fault diagnosis method according to an embodiment of this disclosure.

FIG. 8 shows an example of a diagram of a structure of a possible vehicle fault diagnosis apparatus according to an embodiment of this disclosure.

FIG. 9 shows an example of a diagram of a structure of another possible vehicle fault diagnosis apparatus according to an embodiment of this disclosure.

### DETAILED DESCRIPTION

Before technical solutions provided in this disclosure are described, a part of terms in this disclosure are first explained and described, to facilitate understanding by a person skilled in the art.

Generative AI is AI that focuses on generating or creating new content. Generative AI uses existing large datasets, such as texts, audios, or images, for machine learning, and then generates brand-new content. Generative AI may be implemented based on various technologies, including deep learning and generative adversarial networks (GANs), and the like. For example, deep learning trains neural networks to learn features and patterns of input data, and generate new data according to the patterns. In the GANs, two neural networks may play a game, where one generator network is responsible for generating new data, and the other discriminator network is responsible for determining whether the generated data is real, thereby driving the generator network to continuously improve generation quality.

The following describes in detail embodiments of this disclosure with reference to accompanying drawings.

The following describes an application scenario to which a vehicle fault diagnosis method provided in this disclosure is applicable. It should be noted that these descriptions are intended to facilitate understanding by a person skilled in the art, and are not intended to limit the protection scope claimed by this disclosure.

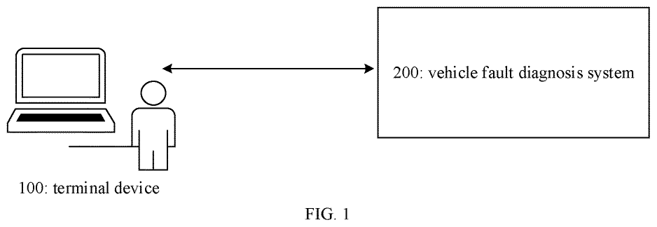

FIG. 1 shows an example of a diagram of a possible application scenario to which an embodiment of this disclosure is applicable. As shown in FIG. 1, the application scenario may include a terminal device 100 and a vehicle fault diagnosis system 200. In some instances, the terminal device 100 may be communicatively connected to the vehicle fault diagnosis system 200 through one or more networks. The network may be a wireless network. For example, the wireless network may be a Wi-Fi network, or may be a mobile cellular network, or may be a network in another form. This is not limited in embodiments of this disclosure.

A target application used to assist a user (for example, a vehicle user) in diagnosing a vehicle fault is installed on the terminal device 100. For example, the user is the vehicle user. The vehicle user may edit and submit, to the vehicle fault diagnosis system 200 through the target application, related information of a to-be-diagnosed vehicle (for example, a first vehicle) (for example, fault description information (which may alternatively be referred to as a fault symptom), a vehicle name, a vehicle model and a vehicle series, purchase time, a vehicle identifier (which may alternatively be referred to as a vehicle index), or a fault occurrence time period (or fault occurrence time) of the vehicle). In some instances, the vehicle user may alternatively not provide the vehicle name (or the vehicle identifier) of the to-be-diagnosed vehicle. Because each vehicle user has registered the vehicle name (or the vehicle identifier) of the vehicle in a process of registering with the target application, a fault symptom data stream (which may alternatively be referred to as a fault symptom data packet) transmitted by the vehicle user to the vehicle fault diagnosis system 200 through the target application automatically carries the vehicle name (or the vehicle identifier) of the vehicle.

For example, the target application may be a client (for example, a head unit client, a personal computer (PC) client, or a mobile phone client), a web-based application, or a mini-program embedded in another application. In this way, the user can feed back the fault symptom of the vehicle in time and effectively. In some instances, the terminal device 100 may also include a display configured to present a fault description interface provided by the vehicle fault diagnosis system 200, to implement human-machine interaction. For example, information edited by the user or information provided for the user is displayed in the fault description interface. The fault description interface is used to prompt the user of the first vehicle to input a fault diagnosis requirement. The fault diagnosis requirement may include second fault description data of the to-be-diagnosed vehicle. For example, the second fault description data may include the fault symptom of the vehicle, or may further include the vehicle name (or the vehicle identifier) of the to-be-diagnosed vehicle. In some instances, the fault diagnosis requirement may further include at least one of the following: a user identifier corresponding to the to-be-diagnosed vehicle, the fault occurrence time period (or occurrence time) of the vehicle, time at which the user submits the fault symptom, the vehicle model and the vehicle series of the vehicle, a vehicle configuration of the vehicle, purchase time of the vehicle, or the like. For example, the user may provide the fault symptom of the vehicle to the vehicle fault diagnosis system 200 in the fault description interface in one or more of input modes such as voice input (for example, describing the fault symptom of the vehicle in a voice form), text input (for example, describing the fault symptom of the vehicle in a text form), recording (or sound) upload (for example, uploading a recording or a sound used to describe the fault symptom), or picture upload (for example, uploading a picture including the fault symptom).

In some instances, the terminal device may also be referred to as a terminal, user equipment (UE), an access terminal device, an in-vehicle terminal, a UE unit, a UE station, a mobile station (MS), a mobile terminal (MT), a remote station, a remote terminal device, a mobile device, a UE terminal device, a terminal device, a wireless communication device, a UE agent, a UE apparatus, or the like. In this embodiment of this disclosure, the terminal device may be at a fixed location, or may be mobile. This is not limited in embodiments of this disclosure.

For example, the terminal device 100 may be a smartphone, a tablet computer, a desktop computer, a computer with a wireless transceiver function (for example, a notebook computer), a personal digital assistant (PDA), a mobile internet device (MID), an in-vehicle terminal device, a wearable device with a wireless communication function (for example, a smartwatch, a smart band, smart glasses, or a smart helmet), a virtual reality (VR) device, or an augmented reality (AR) device. It should be understood that a device form of the terminal device is not limited in this disclosure.

The vehicle fault diagnosis system 200 may be a device (for example, a cloud server or a cloud compute device) that provides a vehicle fault diagnosis service for the user. The vehicle fault diagnosis system 200 provides a corresponding vehicle fault diagnosis report for the user in response to a related operation of the user on the target application (for example, the user describes the fault symptom of the vehicle on the target application) on the terminal device 100. For example, the vehicle fault diagnosis system 200 may be an independent physical server, or may be a server cluster or a distributed system including a plurality of physical servers. For example, the vehicle fault diagnosis system 200 may be a cloud server (which may alternatively be referred to as a cloud, a cloud side, a server side, or a cloud computing device) configured to provide a cloud computing service like a cloud service, cloud computing, cloud storage, cloud communication, a network service, a security service, or big data, or may be a common data center, a server, or a compute device in another form.

For example, the terminal device 100 is a smartphone, and the target application is a client that is installed on the smartphone and used to assist a user in diagnosing a vehicle fault. When a vehicle (for example, a vehicle A) owned by a vehicle user (for example, a user A) has a fault (for example, a battery high-temperature alarm, a battery short circuit, or a sensor fault), the user may log in, through the client installed on the smartphone, to the fault description interface provided by the vehicle fault diagnosis system 200, and may describe a fault symptom of the vehicle A in the fault description interface in a voice input mode (or in a combination of the voice input mode and the text input mode or in another mode). For example, the user may describe, by voice, a symptom of a battery high-temperature alarm of the vehicle, a time period in which the vehicle has the fault, or a vehicle name (or a vehicle identifier, a vehicle model, a vehicle series, or the like) or the like of the vehicle A. Then, in response to the voice-based fault description operation performed by the user A on the client for the vehicle A, the vehicle fault diagnosis system 200 may obtain the fault symptom of the vehicle A, the time period in which the vehicle A has the fault, or the vehicle name (or the vehicle identifier) or the like of the vehicle A, and then may perform a vehicle fault diagnosis procedure for the vehicle A.

In some instances, the vehicle fault diagnosis method provided in embodiments of this disclosure may be applied to a plurality of fields (for example, the field of electric vehicles or the field of any connected vehicles). For example, the vehicle fault diagnosis method provided in embodiments of this disclosure is applicable to vehicle operation and maintenance or another scenario (for example, pre-sales consultation, insurance consultation, or insurance loss assessment).

It should be noted that FIG. 1 provides only an example of the possible application scenario. The example application scenario is intended to describe the technical solutions in embodiments of this disclosure more clearly, and is not intended to limit an application scenario of the vehicle fault diagnosis method provided in this disclosure. In addition, forms and quantities of devices in the application scenario shown in FIG. 1 are merely used as examples, and do not constitute a limitation on this disclosure. In addition, names of the devices in the application scenario shown in FIG. 1 are merely examples, and the names of the devices may alternatively be other names during an implementation. This is not limited in this disclosure. In addition, a person of ordinary skill in the art may learn that, with emergence of a new application scenario, the technical solutions provided in embodiments of this disclosure are also applicable to a similar technical problem.

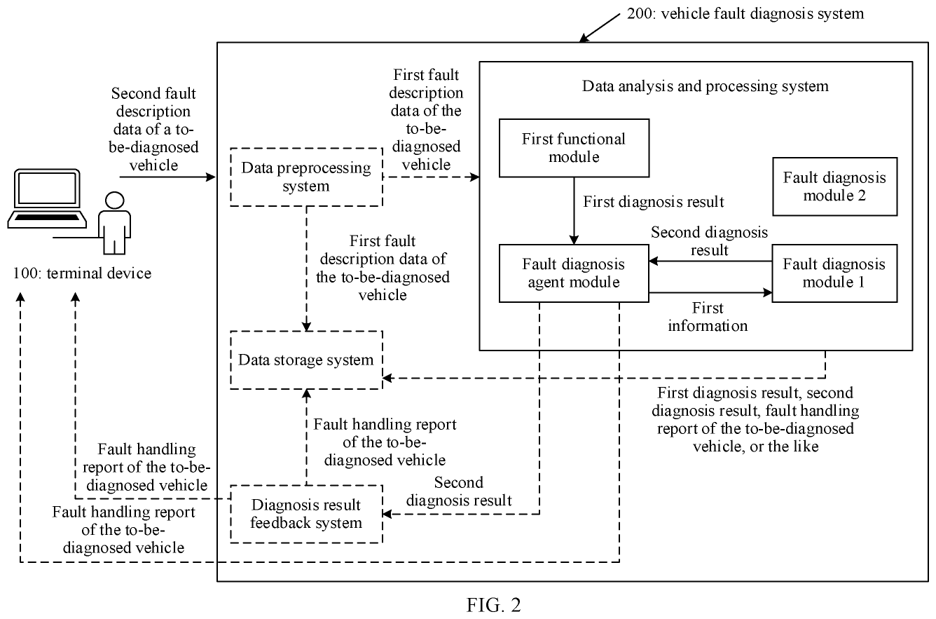

Based on the application scenario shown in FIG. 1, this disclosure further provides a functional module structure of a vehicle fault diagnosis system. As shown in FIG. 2, through division based on logical functions, the vehicle fault diagnosis system may include a data analysis and processing system (which may alternatively be referred to as a data analysis and processing apparatus or a data analysis and processing module). In some instances, the data analysis and processing system may include a vehicle fault diagnosis apparatus (which may alternatively be referred to as a vehicle fault diagnosis module or a vehicle fault diagnosis unit), or the data analysis and processing system may include the vehicle fault diagnosis apparatus and one or more fault diagnosis modules (which may alternatively be referred to as fault detection services, fault detection microservices, fault diagnosis tools, fault detection tools, or fault diagnosis services). In this case, the one or more fault diagnosis modules (for example, a fault diagnosis module 1 and a fault diagnosis module 2) may be located in the data analysis and processing system, or may exist independently of the data analysis and processing system. It should be understood that, when the one or more fault diagnosis modules exist independently of the data analysis and processing system, the one or more fault diagnosis modules are still located in the vehicle fault diagnosis system. For example, the fault diagnosis module may include but is not limited to a battery fault diagnosis module (which may alternatively be referred to as a battery detection service), a motor fault diagnosis module (which may alternatively be referred to as a motor detection service), a chassis fault diagnosis module (which may alternatively be referred to as a chassis detection service), or another component fault diagnosis module (for example, a vehicle window fault diagnosis module or a vehicle light fault diagnosis module).

In some instances, the vehicle fault diagnosis system may further include at least one of the following: a data storage system (which may alternatively be referred to as a data storage module or a data storage apparatus), a data preprocessing system (which may alternatively be referred to as a data preprocessing module or a data preprocessing apparatus), or a diagnosis result feedback system (which may alternatively be referred to as a diagnosis result feedback module or a diagnosis result feedback apparatus).

In an example, the vehicle fault diagnosis apparatus may be a functional module (which may be referred to as a functional component or a functional element) configured with (or running or provided with) a fault diagnosis model, and may be referred to as a first functional module (or a first functional component or a first functional element) for short; or may be a compute device configured with the fault diagnosis model, and may be referred to as a first compute device for short; or may be a fault diagnosis agent module configured with the fault diagnosis model. It should be understood that the functional module configured with the fault diagnosis model is referred to as the first functional module for short below, and the compute device configured with the fault diagnosis model is referred to as the first compute device for short below. In another example, the vehicle fault diagnosis apparatus may alternatively be a fault diagnosis agent module (for example, a fault detection agent, which may alternatively be referred to as a fault diagnosis agent). In another example, the vehicle fault diagnosis apparatus may alternatively be a unit (or a module) formed by integrating a first functional module (or a first compute device) with a fault diagnosis agent module (which may alternatively be referred to as a fault diagnosis agent service, a fault diagnosis agent apparatus, a fault diagnosis agent device, a fault diagnosis agent component, or a fault diagnosis agent assembly). The integrated unit may be implemented in a form of hardware, or may be implemented in a form of a software functional unit. It should be understood that both the first functional module (or the first compute device) and the fault diagnosis agent module are located in the data analysis and processing system.

For example, the following briefly describes functions of the vehicle fault diagnosis apparatus by using the following several possible examples.

Example 1: When the vehicle fault diagnosis apparatus is the first functional module (or the first compute device), the vehicle fault diagnosis apparatus is configured to obtain a first diagnosis result through the fault diagnosis model.

Example 2: When the vehicle fault diagnosis apparatus is the fault diagnosis agent module, the vehicle fault diagnosis apparatus is configured to: after receiving a first diagnosis result, identify the first diagnosis result, and determine whether the first diagnosis result includes information about a first fault diagnosis module (for example, the fault diagnosis module 1). For example, the vehicle fault diagnosis apparatus may parse the first diagnosis result to obtain a parsed first diagnosis result, and identify whether the parsed first diagnosis result includes the information about the first fault diagnosis module. For example, the parsed first diagnosis result may include a first fault cause of a to-be-diagnosed vehicle, or may not include the first fault cause of the to-be-diagnosed vehicle (for example, the fault diagnosis model determines that the to-be-diagnosed vehicle has no fault). It should be understood that, regardless of whether the parsed first diagnosis result includes the first fault cause of the to-be-diagnosed vehicle, the parsed first diagnosis result may include the information about the first fault diagnosis module, or may not include the information about the first fault diagnosis module.

When the first diagnosis result does not include the information about the first fault diagnosis module, the vehicle fault diagnosis apparatus may generate a fault handling report of the to-be-diagnosed vehicle based on the first diagnosis result. Then, the vehicle fault diagnosis apparatus may feed back the fault handling report of the to-be-diagnosed vehicle to the to-be-diagnosed vehicle (or a user of the to-be-diagnosed vehicle or a manufacturer corresponding to the to-be-diagnosed vehicle). In some instances, when the vehicle fault diagnosis system includes the diagnosis result feedback system, after determining that the first diagnosis result does not include the information about the first fault diagnosis module, the vehicle fault diagnosis apparatus may alternatively send the first diagnosis result (for example, indicating a fault cause of the to-be-diagnosed vehicle or indicating that the to-be-diagnosed vehicle has no fault) to the diagnosis result feedback system, and the diagnosis result feedback system generates the fault handling report of the to-be-diagnosed vehicle.

When the first diagnosis result includes the information about the first fault diagnosis module, the vehicle fault diagnosis apparatus may invoke the first fault diagnosis module (for example, send an invocation indication or an invocation instruction to the first fault diagnosis module) or send first information to the first fault diagnosis module, and may generate the fault handling report of the to-be-diagnosed vehicle based on a second diagnosis result from the first fault diagnosis module. Then, the vehicle fault diagnosis apparatus may feed back the fault handling report of the to-be-diagnosed vehicle to the to-be-diagnosed vehicle (or the user of the to-be-diagnosed vehicle or the manufacturer corresponding to the to-be-diagnosed vehicle). The first information (or the invocation indication or the invocation instruction) indicates to perform fault diagnosis on the to-be-diagnosed vehicle. The first information (or the invocation indication or the invocation instruction) may include related information of the to-be-diagnosed vehicle (which may alternatively be referred to as information about the to-be-diagnosed vehicle). For example, the related information of the to-be-diagnosed vehicle may include but is not limited to a vehicle identifier (or a vehicle name) of the to-be-diagnosed vehicle, a vehicle model and a vehicle series of the to-be-diagnosed vehicle, time (or a time period) at (or in) which the to-be-diagnosed vehicle has a fault, or time at which the user submits a fault symptom. In some instances, when the vehicle fault diagnosis system includes the diagnosis result feedback system, after receiving the second diagnosis result (for example, indicating the fault cause of the to-be-diagnosed vehicle or indicating that the to-be-diagnosed vehicle has no fault) from the first fault diagnosis module, the vehicle fault diagnosis apparatus may alternatively send the second diagnosis result to the diagnosis result feedback system, and the diagnosis result feedback system generates the fault handling report of the to-be-diagnosed vehicle. For example, the second diagnosis result may include a second fault cause of the to-be-diagnosed vehicle, or may not include the second fault cause of the to-be-diagnosed vehicle (for example, the first fault diagnosis module determines that the to-be-diagnosed vehicle has no fault).

For example, the vehicle fault diagnosis apparatus sends the invocation instruction to the first fault diagnosis module. The vehicle fault diagnosis apparatus may generate the invocation instruction (for example, a post https://xxx.service.com/start/{id:xxx,time:202307081230 instruction) based on the obtained related information (for example, the vehicle name (or the vehicle identifier), the vehicle model and the vehicle series, purchase time, or the fault occurrence time) of the to-be-diagnosed vehicle, and may send the invocation instruction to the first fault diagnosis module. The invocation instruction indicates to perform fault diagnosis on the to-be-diagnosed vehicle. For example, the invocation instruction may include the vehicle identifier (or the vehicle name) of the to-be-diagnosed vehicle, or the invocation instruction may include the vehicle identifier (or the vehicle name) of the to-be-diagnosed vehicle and current time, or the invocation instruction may include the vehicle identifier (or the vehicle name) of the to-be-diagnosed vehicle and the fault occurrence time (or the fault occurrence time period), or the invocation instruction may include the vehicle identifier (or the vehicle name) of the to-be-diagnosed vehicle, the current time, the fault occurrence time (or the fault occurrence time period), and the vehicle model and the vehicle series of the to-be-diagnosed vehicle.

For example, the fault handling report of the to-be-diagnosed vehicle may include but is not limited to the fault cause (which may alternatively be referred to as a fault type) of the to-be-diagnosed vehicle, a fault level corresponding to the fault cause of the to-be-diagnosed vehicle, a handling scheme (which may alternatively be referred to as a handling suggestion) corresponding to the fault cause of the to-be-diagnosed vehicle, or whether the to-be-diagnosed vehicle has a fault.

Example 3: When the vehicle fault diagnosis apparatus is the integrated unit of the first functional module (or the first compute device) and the fault diagnosis agent module (or the fault diagnosis agent module configured with the fault diagnosis model), the vehicle fault diagnosis apparatus is configured to: obtain a first diagnosis result through the fault diagnosis model, identify the first diagnosis result, and determine whether the first diagnosis result includes information about a first fault diagnosis module. When the first diagnosis result does not include the information about the first fault diagnosis module, the vehicle fault diagnosis apparatus may generate a fault handling report of a to-be-diagnosed vehicle based on the first diagnosis result, and may feed back the fault handling report of the to-be-diagnosed vehicle to the to-be-diagnosed vehicle (or a user of the to-be-diagnosed vehicle or a manufacturer corresponding to the to-be-diagnosed vehicle). When the first diagnosis result includes the information about the first fault diagnosis module, the vehicle fault diagnosis apparatus may invoke the first fault diagnosis module or send first information to the first fault diagnosis module, and may generate the fault handling report of the to-be-diagnosed vehicle based on a second diagnosis result from the first fault diagnosis module. Then, the vehicle fault diagnosis apparatus may feed back the fault handling report of the to-be-diagnosed vehicle to the to-be-diagnosed vehicle (or the user of the to-be-diagnosed vehicle or the manufacturer corresponding to the to-be-diagnosed vehicle). In some instances, when the vehicle fault diagnosis system includes the diagnosis result feedback system, after receiving the second diagnosis result from the first fault diagnosis module, the vehicle fault diagnosis apparatus may alternatively send the second diagnosis result to the diagnosis result feedback system, and the diagnosis result feedback system generates the fault handling report of the to-be-diagnosed vehicle.

The following briefly describes functions of the fault diagnosis modules.

Each fault diagnosis module is configured to perform fault diagnosis on the to-be-diagnosed vehicle after receiving an invocation indication (or an invocation instruction or the first information), to obtain a second diagnosis result. For example, the to-be-diagnosed vehicle is a vehicle A, the first fault cause that is of the to-be-diagnosed vehicle and that is included in the first diagnosis result is that a battery fault may exist, and information that is about a fault diagnosis module and that is included in the first diagnosis result is that the battery detection service needs to be used for confirmation. After receiving an invocation indication (or an invocation instruction or the first information), the battery detection service obtains, from a database (or a data storage node or a data storage area) used to store data (for example, controller area network (CAN) signal data, local interconnect network (LIN) signal data, or Ethernet (ETH) signal data) reported by the vehicle, battery data that is reported by the vehicle A and timestamped within a period of time before and after current time. Then, the battery detection service may analyze and process the battery data timestamped within the period of time before and after the current time, to obtain a second diagnosis result of the vehicle A.

In some instances, based on time at which the vehicle A has the fault (for example, 9:00 on MM DD, YYYY), the battery detection service may obtain, from the database (or the data storage node or the data storage area) used to store the data reported by the vehicle, battery data that is reported by the vehicle A and timestamped at 9:00 on MM DD, YYYY. Then, the battery detection service may analyze and process the battery data timestamped at 9:00 on MM DD, YYYY, to obtain the second diagnosis result of the vehicle A. In some instances, the battery detection service may alternatively obtain, from the database (or the data storage node or the data storage area) used to store the data reported by the vehicle, battery data reported by the vehicle A within a period of time (for example, 8:50 to 9:10) before and after 9:00 on MM DD, YYYY, and analyze and process the battery data timestamped within the period of time (for example, 8:50 to 9:10) before and after 9:00 on MM DD, YYYY, to obtain the second diagnosis result of the vehicle A.

For ease of description of the technical solutions provided in embodiments of this disclosure, in FIG. 2, an example in which the data analysis and processing system includes two vehicle fault diagnosis apparatuses (for example, the first functional module and the fault diagnosis agent module) and the one or more fault diagnosis modules (for example, the fault diagnosis module 1 and the fault diagnosis module 2) is used to describe functions of the data analysis and processing system. In FIG. 2, data exchange is performed between the fault diagnosis agent module and the fault diagnosis module 1. For example, the fault diagnosis agent module sends the first information to the fault diagnosis module 1, and the fault diagnosis module 1 sends the second diagnosis result to the fault diagnosis agent module.

It should be noted that a connection relationship between the functional modules shown in FIG. 2 is merely an example, and does not constitute a limitation on this disclosure. The following separately describes functions of the functional modules.

When the vehicle fault diagnosis system includes the data preprocessing system, the data preprocessing system is configured to obtain second fault description data of the to-be-diagnosed vehicle from the data storage system, or may directly obtain the second fault description data that is of the to-be-diagnosed vehicle and that is submitted by the user through a target application on a terminal device, and perform preprocessing (for example, data cleaning and data extraction) on the second fault description data, to obtain first fault description data of the to-be-diagnosed vehicle. In some instances, when the vehicle fault diagnosis system includes the data storage system, the data preprocessing system may store the first fault description data in the data storage system. When the data preprocessing system directly obtains the second fault description data submitted by the user through the target application on the terminal device, the data preprocessing system may also store the second fault description data in the data storage system. In some instances, the data preprocessing system may also store, in the data storage system, other content (for example, one or more of a user identifier corresponding to the to-be-diagnosed vehicle, the fault occurrence time period (or occurrence time) of the vehicle, the time at which the user submits the fault symptom, the vehicle model and the vehicle series of the vehicle, a vehicle configuration of the vehicle, or the purchase time of the vehicle) included in a fault diagnosis requirement submitted by the user through the target application on the terminal device.

For example, when performing data cleaning on the second fault description data, the data preprocessing system may clean noise data in the second fault description data, to obtain cleaned second fault description data. Then, the data preprocessing system may perform data extraction on the cleaned second fault description data, for example, may extract the related information of the vehicle (for example, the vehicle name (or the vehicle identifier), the vehicle model and the vehicle series, the purchase time, or the fault occurrence time of the vehicle) and fault description information (which may alternatively be understood as the fault symptom, for example, fault information described by voice, the fault information described in text, or the fault information described in another mode) from the cleaned second fault description data. Then, the data preprocessing system may send the related information of the vehicle to the fault diagnosis agent module (or the integrated unit of the first functional module and the fault diagnosis agent module).

For the fault description information, the data preprocessing system may send the fault description information to the first functional module (or the integrated unit of the first functional module and the fault diagnosis agent module) as the first fault description data, or may perform format conversion on the fault description information to obtain converted fault description information, and send the converted fault description information to the first functional module (or the integrated unit of the first functional module and the fault diagnosis agent module). For example, a data type of the fault description information may include but is not limited to a voice, a text, a picture, or a recording (or a sound), and a data type of the converted fault description information may include but is not limited to a numerical value or a vector.

The data analysis and processing system is configured to perform fault diagnosis on the to-be-diagnosed vehicle (for example, a first vehicle), to obtain the first diagnosis result, and may be configured to generate the fault handling report of the to-be-diagnosed vehicle based on the first diagnosis result.

In an example, when the vehicle fault diagnosis system includes the data preprocessing system, the data analysis and processing system is configured to: obtain the first fault description data of the to-be-diagnosed vehicle from the data preprocessing system, and process the first fault description data of the to-be-diagnosed vehicle through the first functional module, to obtain the first diagnosis result. In another example, when the vehicle fault diagnosis system does not include the data preprocessing system, if the data analysis and processing system has a data preprocessing function, the data analysis and processing system may perform preprocessing (for example, data cleaning and data extraction) on the second fault description data of the to-be-diagnosed vehicle, to obtain the first fault description data of the to-be-diagnosed vehicle. Then, the data analysis and processing system is configured to process the first fault description data of the to-be-diagnosed vehicle through the first functional module, to obtain the first diagnosis result. After obtaining the first diagnosis result, the data analysis and processing system may perform fault diagnosis on the to-be-diagnosed vehicle through the fault diagnosis module 1 when determining, through the fault diagnosis agent module, that the first diagnosis result includes the information about a fault diagnosis module (for example, the fault diagnosis module 1), to obtain the second diagnosis result. For example, when the vehicle fault diagnosis system includes the data storage system, the data analysis and processing system may store the first diagnosis result, the second diagnosis result, or the fault handling report of the to-be-diagnosed vehicle in the data storage system.

For example, the first diagnosis result may include the first fault cause (which may alternatively be referred to as a first fault type) of the to-be-diagnosed vehicle and/or information about a fault diagnosis module (for example, whether the fault diagnosis module (for example, the fault diagnosis module 1) needs to be used for confirmation (or whether an operation instruction (which may alternatively be referred to as an operation indication) for invoking the fault diagnosis module (for example, the fault diagnosis module 1) to perform fault diagnosis on the to-be-diagnosed vehicle may be required), and attribute information (for example, an identifier, a name, or an API of the fault diagnosis module (for example, the fault diagnosis module 1)), or the first diagnosis result does not include the first fault cause of the to-be-diagnosed vehicle (for example, the fault diagnosis model determines that the to-be-diagnosed vehicle has no fault) and does not include the information about the fault diagnosis module. For example, the second diagnosis result may include the second fault cause of the to-be-diagnosed vehicle, or may not include the second fault cause of the to-be-diagnosed vehicle (for example, the fault diagnosis module 1 determines that the to-be-diagnosed vehicle has no fault). The fault handling report of the to-be-diagnosed vehicle may include but is not limited to the fault cause (which may alternatively be referred to as the fault type) of the to-be-diagnosed vehicle, the fault level corresponding to the fault cause of the to-be-diagnosed vehicle, the handling scheme corresponding to the fault cause of the to-be-diagnosed vehicle, whether the to-be-diagnosed vehicle has a fault, or the like.

When the vehicle fault diagnosis system includes the data storage system, the data storage system is configured to store at least one of the following: the first fault description data, the second fault description data, the first diagnosis result, the second diagnosis result, the fault handling report, the user identifier, the fault occurrence time period (or occurrence time) of the vehicle, the time at which the user submits the fault symptom, the vehicle model and the vehicle series of the vehicle, the vehicle identifier of the vehicle, the vehicle name of the vehicle, the vehicle configuration of the vehicle, the purchase time of the vehicle, or the like.

When the vehicle fault diagnosis system includes the diagnosis result feedback system, the diagnosis result feedback system is configured to: after receiving the first diagnosis result, generate the fault handling report of the to-be-diagnosed vehicle based on the first diagnosis result, and feed back the fault handling report of the to-be-diagnosed vehicle to the to-be-diagnosed vehicle (or the user of the to-be-diagnosed vehicle or the manufacturer corresponding to the to-be-diagnosed vehicle); or may be configured to: after receiving the second diagnosis result, generate the fault handling report of the to-be-diagnosed vehicle based on the second diagnosis result, and feed back the fault handling report of the to-be-diagnosed vehicle to the to-be-diagnosed vehicle (or the user of the to-be-diagnosed vehicle or the manufacturer corresponding to the to-be-diagnosed vehicle). For example, when the vehicle fault diagnosis system includes the data storage system, after generating the fault handling report of the to-be-diagnosed vehicle, the diagnosis result feedback system may store the fault handling report of the to-be-diagnosed vehicle in the data storage system.

In some instances, the data analysis and processing system, the vehicle fault diagnosis apparatus, the one or more fault diagnosis modules, the first functional module, the fault diagnosis agent module, the data storage system, the data preprocessing system, or the diagnosis result feedback system may be implemented by software, or may be implemented by hardware. For example, the following uses the fault diagnosis agent module as an example to describe an implementation of the fault diagnosis agent module. Similarly, for an implementation of the data analysis and processing system, the vehicle fault diagnosis apparatus, the one or more fault diagnosis modules, the first functional module, the data storage system, the data preprocessing system, or the diagnosis result feedback system, refer to the implementation of the fault diagnosis agent module. Details are not described herein again.

When being implemented by the software, the fault diagnosis agent module may be an application or a code block running on a compute device (or a control unit or the like) that has a data processing capability in the data analysis and processing system (or the vehicle fault diagnosis system). The compute device may be at least one of compute devices such as a physical host, a virtual machine, and a container. Further, there may be one or more compute devices. For example, the object detection module may be an application running on a plurality of hosts/virtual machines/containers.

When being implemented by the hardware, the fault diagnosis agent module may include at least one compute device, for example, a server. Alternatively, the object detection module may be a device implemented by using an application-specific integrated circuit (ASIC) or a programmable logic device (PLD). The PLD may be a complex PLD (CPLD), a field-programmable gate array (FPGA), generic array logic (GAL), or any combination thereof.

In addition, it should be noted that, in this embodiment of this disclosure, division into the modules is an example, is merely logical function division, and may be other division during an implementation. The functional modules in this embodiment of this disclosure may be integrated into one module, or each of the modules may exist alone physically, or two or more modules may be integrated into one module. For example, the first functional module and the fault diagnosis agent module may be integrated into one module, or the first functional module and the fault diagnosis agent module are a same module. The integrated unit may be implemented in a form of hardware, or may be implemented in a form of a software functional unit.

The following describes in detail an implementation of the vehicle fault diagnosis method in embodiments of this disclosure based on the application scenario shown in FIG. 1 and the vehicle fault diagnosis system shown in FIG. 2.

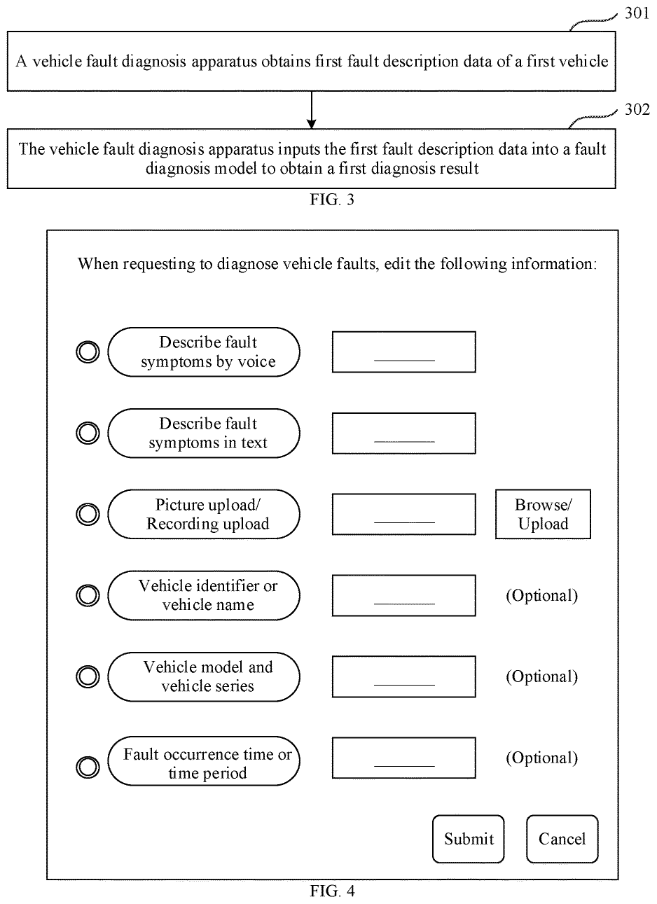

FIG. 3 shows an example of a schematic flowchart of a vehicle fault diagnosis method according to an embodiment of this disclosure. The method is applicable to, but not limited to, the application scenario shown in FIG. 1. The method may be performed by a vehicle fault diagnosis apparatus or an element (for example, a chip, a chip system, or a circuit) that can support the vehicle fault diagnosis apparatus in implementing a function for the method. In an example, the vehicle fault diagnosis apparatus may be the vehicle fault diagnosis apparatus included in the vehicle fault diagnosis system 200 shown in FIG. 1, or may be a functional module (for example, a plug-in, a component, or a chip) disposed in the vehicle fault diagnosis apparatus included in the vehicle fault diagnosis system 200 shown in FIG. 1. The functional module (which may alternatively be referred to as a functional component or a functional element) has a function of implementing the vehicle fault diagnosis method. For example, the vehicle fault diagnosis apparatus may be a first functional module (or a first compute device), or may be a fault diagnosis agent module configured with a fault diagnosis model, or may be an integrated module (which may alternatively be referred to as an integrated unit) of the first functional module (or the first compute device) and the fault diagnosis agent module. In another example, the vehicle fault diagnosis apparatus may alternatively be another device (for example, another compute device or a diagnosis unit) that has a vehicle fault diagnosis function in the vehicle fault diagnosis system 200 shown in FIG. 1, or may be a functional module (for example, a plug-in, a component, or a chip) disposed in the another device that has the vehicle fault diagnosis function in the vehicle fault diagnosis system 200 shown in FIG. 1. To facilitate description of technical solutions provided in this embodiment of this disclosure, the following uses an example in which the vehicle fault diagnosis apparatus performs the vehicle fault diagnosis method for description. As shown in FIG. 3, the method includes steps 301 and 302.

Step 301: The vehicle fault diagnosis apparatus obtains first fault description data of a first vehicle.

In some instances, the first fault description data may be obtained by performing format conversion on second fault description data (or a problem log) of the first vehicle, or the second fault description data (or the problem log) of the first vehicle may be directly used as the first fault description data. In some instances, the second fault description data of the first vehicle may be obtained through user input (for example, submission performed by a user in one or more of input modes such as voice input, text input, recording (or sound) upload, or picture upload through a terminal device). For example, the first vehicle may be any electric vehicle or any other connected vehicle. Further, the first vehicle may be a faulty vehicle that needs to be diagnosed, or may be a vehicle that interacts with a cloud, for example, a faulty vehicle or an entire vehicle (for example, a normal vehicle). It may be understood that, in some scenarios, the problem log may be the second fault description data.

For example, a data type of the second fault description data may include but is not limited to a voice, a text, a picture, or a recording (or a sound).

For example, the second fault description data of the first vehicle may be provided by the user of the first vehicle in one or more of input modes such as voice description, text description, recording (or sound) upload, or picture upload through a target application installed on the terminal device.

For example, the terminal device is a vehicle-mounted terminal device in the first vehicle, and the target application is a client that is installed on the vehicle-mounted terminal device and that is used to assist the user in diagnosing a vehicle fault. When the first vehicle has a fault (for example, a motor cannot be started), the user of the first vehicle may log in, through the client installed on the vehicle-mounted terminal device, to a fault description interface provided by the vehicle fault diagnosis system 200, and may describe a fault symptom of the first vehicle in the fault description interface in the text input mode (or in a combination of the text input mode and the picture upload mode or in another mode). For example, the symptom that the motor of the first vehicle cannot be started is described in text. Alternatively, a time period in which the vehicle has the fault may be further described in text, or a vehicle name (or a vehicle identifier, a vehicle model and a vehicle series, or the like) or the like of the first vehicle may be further described in text. Then, in response to the fault file description operation of the user of the first vehicle on the client for the first vehicle, the vehicle fault diagnosis system 200 may obtain the second fault description data of the first vehicle. For example, the second fault description data may include the fault symptom of the first vehicle, the time period in which the first vehicle has the fault, or the vehicle name (or the vehicle identifier) of the first vehicle. For example, FIG. 4 is a diagram of the fault description interface displayed on the target application. In the fault description interface shown in FIG. 4, some related information (for example, the fault symptom of the first vehicle, the vehicle identifier (or the vehicle name) of the first vehicle, or fault occurrence time (or the fault occurrence time period)) that needs to be edited by the user is displayed. For example, the first vehicle is a vehicle A. The user may input an identifier of the vehicle A, fault occurrence time of the vehicle A, and a fault symptom in the fault description interface in a voice description (or text description, or picture upload, or recording upload) mode. In this example, the user may also take a fault picture (for example, take a battery high-temperature alarm picture) for upload when describing the fault symptom in text. In other words, the user may simultaneously submit fault symptom descriptions of different data types in the fault description interface.

When the vehicle fault diagnosis system 200 includes a data preprocessing system, the vehicle fault diagnosis system 200 may provide the second fault description data for the data preprocessing system. After obtaining the second fault description data, the data preprocessing system may perform preprocessing (for example, data cleaning and data extraction) on the second fault description data, to obtain the first fault description data. For example, the data preprocessing system may first clean noise data in the second fault description data, to obtain cleaned second fault description data. Then, the data preprocessing system may perform data extraction on the cleaned second fault description data, for example, may extract related information (for example, the vehicle name (or the vehicle identifier), the vehicle model and the vehicle series, purchase time, or the fault occurrence time) of the first vehicle and fault description information (which may alternatively be understood as the fault symptom, for example, fault information described in text, the fault information included in a picture, or the fault information described in another mode) from the cleaned second fault description data.

In an example, when the vehicle fault diagnosis apparatus is the first functional module (or the first compute device), the data preprocessing system may perform format conversion on the fault description information, to obtain converted fault description information, which may be used as the first fault description data. Then, the data preprocessing system may provide the first fault description data to the vehicle fault diagnosis apparatus. For example, if the data type of the second fault description data is the text (or a combination of the text and the picture, or another type), a data type of the fault description information is also a text (or a combination of a text and a picture, or another type), and a data type of the first fault description data is a value (or a vector). In some instances, alternatively, the data preprocessing system may directly provide the fault description information to the vehicle fault diagnosis apparatus as the first fault description data. In addition, the data preprocessing system may provide, for the fault diagnosis agent module, the related information that is of the first vehicle and that is included in the second fault description data.

In another example, when the vehicle fault diagnosis apparatus is the fault diagnosis agent module, the data preprocessing system may provide, for the fault diagnosis agent module, the related information that is of the first vehicle and that is included in the second fault description data. In addition, the data preprocessing system may perform format conversion on the fault description information, to obtain converted fault description information, where the converted fault description information may be used as the first fault description data. Then, the data preprocessing system may provide the first fault description data for the first functional module (or the first compute device). Then, the first functional module (or the first compute device) obtains the first diagnosis result based on the first fault description data through the fault diagnosis model, and may provide the first diagnosis result for the fault diagnosis agent module.

In some instances, alternatively, the data preprocessing system may directly provide the fault description information for the first functional module (or the first compute device) as the first fault description data. Then, the first functional module (or the first compute device) obtains the first diagnosis result based on the first fault description data through the fault diagnosis model, and may provide the first diagnosis result for the fault diagnosis agent module.

In another example, when the vehicle fault diagnosis apparatus is the integrated unit of the first functional module (or the first compute device) and the fault diagnosis agent module (or the fault diagnosis agent module configured with the fault diagnosis model), the data preprocessing system may provide, to the vehicle fault diagnosis apparatus, the related information that is of the first vehicle and that is included in the second fault description data. In addition, the data preprocessing system may perform format conversion on the fault description information, to obtain converted fault description information, where the converted fault description information may be used as the first fault description data. Then, the data preprocessing system may provide the first fault description data to the vehicle fault diagnosis apparatus. In some instances, alternatively, the data preprocessing system may directly provide the fault description information to the vehicle fault diagnosis apparatus as the first fault description data.

When the vehicle fault diagnosis system 200 does not include the data preprocessing system, the vehicle fault diagnosis system 200 may provide the second fault description data for a data analysis and processing system. When the data analysis and processing system does not have a data preprocessing function, if the vehicle fault diagnosis apparatus is the integrated unit of the first functional module (or the first computing device) and the fault diagnosis agent module, the fault diagnosis agent module, or the first functional module (or the first computing device), the data analysis and processing system may provide the second fault description data to the vehicle fault diagnosis apparatus.

When the data analysis and processing system has the data preprocessing function, the data analysis and processing system may first clean the noise data and the like in the second fault description data, to obtain the cleaned second fault description data. Then, the data analysis and processing system may perform data extraction on the cleaned second fault description data, for example, may extract the related information of the first vehicle and the fault description information from the cleaned second fault description data. Then, the data analysis and processing system may perform format conversion on the fault description information, to obtain the converted fault description information, where the converted fault description information may be used as the first fault description data. In some instances, alternatively, the data analysis and processing system may directly use the fault description information as the first fault description data.

When the vehicle fault diagnosis apparatus is the first functional module (or the first compute device), the data analysis and processing system may provide the first fault description data to the vehicle fault diagnosis apparatus. In addition, the data analysis and processing system may provide the related information of the first vehicle for the fault diagnosis agent module.

When the vehicle fault diagnosis apparatus is the fault diagnosis agent module, the data analysis and processing system may provide the related information of the first vehicle to the vehicle fault diagnosis apparatus. In addition, the data analysis and processing system may provide the first fault description data for the first functional module (or the first compute device).

When the vehicle fault diagnosis apparatus is the integrated unit of the first functional module (or the first compute device) and the fault diagnosis agent module, the data analysis and processing system may provide the first fault description data and the related information of the first vehicle to the vehicle fault diagnosis apparatus.

Step 302: The vehicle fault diagnosis apparatus inputs the first fault description data into the fault diagnosis model to obtain the first diagnosis result.

The fault diagnosis model (which may alternatively be referred to as a fault detection model or an operation and maintenance model) is used to describe a correspondence between fault description data of a vehicle and a diagnosis result. The first diagnosis result may indicate the fault diagnosis agent module to perform a fault diagnosis operation corresponding to the first diagnosis result (for example, an operation of generating a first fault handling report based on the first diagnosis result, or an operation of sending corresponding information (for example, first information) to a corresponding fault diagnosis module based on the first diagnosis result). For example, the fault diagnosis model may be a trained AI model, or may be a combination of a diagnosis tree knowledge base and the trained AI model. The trained AI model is used to understand or identify a problem description (for example, the second fault description data or the problem log) of the user, or may be used to extract a keyword in the problem description of the user.

The following describes a training process of an AI model.

For example, the AI model is a generative AI model. The generative AI model may be obtained through training by a functional module, or may be obtained through training by a compute device. In some instances, the functional module or the compute device may be located in the vehicle fault diagnosis system 200, or may be located outside the vehicle fault diagnosis system 200.

For example, the compute device (for example, a compute device A) trains the generative AI model. After obtaining a plurality of fault training samples (which may alternatively be referred to as fault training data), the compute device A may train (or iteratively train) the generative AI model (for example, a Pangu model) by using the plurality of fault training samples, until the generative AI model converges or a quantity of training times is reached, to obtain the trained generative AI model. In some instances, the generative AI model is a large multimodal model. A multimodal understanding capability of the large multimodal model may be used to perceive input data of different data types (for example, the user may simultaneously submit fault symptom descriptions of different data types (for example, the user may simultaneously submit any two or more of the fault symptom described by voice, the fault symptom described in text, a picture including the fault symptom, or a recording (or a sound) including the fault symptom)). In this way, the fault symptom descriptions submitted by the user can be comprehensively understood.

For example, the fault training sample may include a questionnaire (which may alternatively be understood as a fault questionnaire), a repair order (which may alternatively be understood as a fault repair order), and repair training material (which may alternatively be understood as fault repair training material). For example, the questionnaire, the repair order, and the repair training material may all include but are not limited to the fault symptom (which may alternatively be referred to as the fault description information or fault description data) and a fault cause (which may alternatively be referred to as a fault type). In some instances, the questionnaire, the repair order, and the repair training material may further include information about the fault diagnosis module (for example, whether the fault diagnosis module needs to be used for confirmation (or re-diagnosis) or attribute information (for example, an identifier, a name, or an API) of the fault diagnosis module). In an example, for a content form of the questionnaire (or the repair order or the repair training material), refer to Table 1. It should be understood that Table 1 is merely an example, and is intended to facilitate description of the technical solutions in this embodiment of this disclosure, but does not constitute a limitation on the technical solutions in this embodiment of this disclosure.

TABLE 1
Content of a fault training sample

| | |
|---|---|
| Fault | Fault cause, whether a fault diagnosis module needs to be |
| symptom | used for confirmation, and API of the fault diagnosis module |

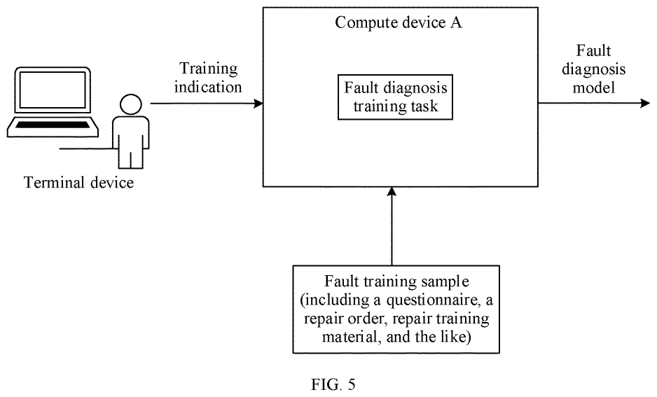

In some instances, a training process of the generative AI model may be encapsulated into a fault diagnosis training task (which may alternatively be referred to as a fault detection training task). FIG. 5 is a diagram of training the generative AI model according to an embodiment of this disclosure. As shown in FIG. 5, after obtaining a training indication (the training indication indicates to train the Pangu model, and the training indication includes the Pangu model) delivered by the user through the terminal device (for example, a smartphone, a notebook computer, or a desktop computer), a training device (for example, the compute device A) may obtain the fault training sample (for example, the questionnaire, the repair order, and the repair training material) from a database (or a data storage area) used to store the fault training sample, and execute the fault diagnosis training task. In this way, the trained generative AI model can be obtained. In some instances, the compute device A may alternatively obtain the Pangu model in advance, and after obtaining the training indication (the training indication indicates to train the Pangu model) delivered by the user through the terminal device, obtain the fault training sample (for example, the questionnaire, the repair order, and the repair training material) from the database (or the data storage area) used to store the fault training sample, and execute the fault diagnosis training task. In this way, the trained generative AI model can be obtained.

For example, the following describes, by using the following several possible implementations, an implementation process in which the vehicle fault diagnosis apparatus inputs the first fault description data into the fault diagnosis model to obtain the first diagnosis result.

Implementation 1: When the vehicle fault diagnosis apparatus is the first functional module (or the first compute device), after obtaining the first fault description data, the vehicle fault diagnosis apparatus may input the first fault description data into the fault diagnosis model to obtain the first diagnosis result.

In an example, the first diagnosis result includes a first fault cause of the first vehicle. In another example, the first diagnosis result includes a first fault cause of the first vehicle and information about a first fault diagnosis module (for example, whether the first fault diagnosis module needs to be used for confirmation or attribute information (for example, an identifier, a name, or an API) of the first fault diagnosis module). In another example, the first diagnosis result does not include a first fault cause of the first vehicle (for example, the fault diagnosis model determines that the first vehicle has no fault), and does not include information about any fault diagnosis module (for example, a first fault diagnosis module). In another example, the first diagnosis result does not include a first fault cause of the first vehicle, but includes information about a first fault diagnosis module.

In some instances, the first diagnosis result may indicate the fault diagnosis agent module to perform the fault diagnosis operation corresponding to the first diagnosis result. After obtaining the first diagnosis result, the first functional module (or the first compute device) may send the first diagnosis result to the fault diagnosis agent module. After receiving the first diagnosis result, the fault diagnosis agent module may perform, based on the first diagnosis result, the fault diagnosis operation corresponding to the first diagnosis result.

For example, the following describes, by using the following several possible examples, an implementation process in which the fault diagnosis agent module performs, based on the first diagnosis result, the fault diagnosis operation corresponding to the first diagnosis result. In some instances, after receiving the first diagnosis result, the fault diagnosis agent module may identify the first diagnosis result, and determine whether the first diagnosis result includes the information about the first fault diagnosis module. For example, the fault diagnosis agent module may parse the first diagnosis result to obtain a parsed first diagnosis result.

Example 1: When the parsed first diagnosis result does not include the information about the first fault diagnosis module, the fault diagnosis agent module may generate the first fault handling report of the first vehicle based on the first diagnosis result. For example, the first diagnosis result includes the first fault cause of the first vehicle. The fault diagnosis agent module may determine, based on the first fault cause, a fault level corresponding to the first fault cause, and may obtain, from a database (or a data storage area) used to store a handling scheme corresponding to a fault cause, a handling scheme (which may alternatively be referred to as a handling manner, a handling suggestion, a fault handling scheme, a fault handling manner, or a fault handling suggestion) corresponding to the first fault cause. Then, the fault diagnosis agent module may generate the first fault handling report of the first vehicle based on the first fault cause, the fault level corresponding to the first fault cause, and the handling scheme corresponding to the first fault cause. Then, the fault diagnosis agent module may send the first fault handling report of the first vehicle to the first vehicle (or the user of the first vehicle or a manufacturer corresponding to the first vehicle). In some instances, the fault diagnosis agent module may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

Example 2: When the parsed first diagnosis result includes the information about the first fault diagnosis module, based on the information about the first fault diagnosis module, the fault diagnosis agent module may invoke the first fault diagnosis module (for example, send an invocation indication or an invocation instruction to the first fault diagnosis module), or send the first information to the first fault diagnosis module.

For example, the fault diagnosis agent module sends the first information to the first fault diagnosis module. The fault diagnosis agent module may generate the first information based on the obtained related information (for example, the vehicle name (or the vehicle identifier), the vehicle model and the vehicle series, the purchase time, or the fault occurrence time) of the first vehicle, and may send the first information to the first fault diagnosis module. The first information indicates to perform fault diagnosis on the first vehicle. For example, the first information may include the vehicle identifier (or the vehicle name) of the first vehicle, or the first information may include the vehicle identifier (or the vehicle name) of the first vehicle and current time, or the first information may include the vehicle identifier (or the vehicle name) of the first vehicle and the fault occurrence time (or the fault occurrence time period), or the first information may include the vehicle identifier (or the vehicle name) of the first vehicle, the current time, the fault occurrence time (or the fault occurrence time period), and the vehicle model and the vehicle series of the first vehicle. After obtaining the first information from the fault diagnosis agent module, the first fault diagnosis module may perform fault diagnosis on the first vehicle to obtain a second diagnosis result, and may send the second diagnosis result to the fault diagnosis agent module. For example, the second diagnosis result may include a second fault cause of the first vehicle, or may not include the second fault cause of the first vehicle (for example, the first fault diagnosis module determines that the first vehicle has no fault).

After obtaining the second diagnosis result from the first fault diagnosis module, the fault diagnosis agent module may generate the first fault handling report of the first vehicle based on the second diagnosis result. For example, the second diagnosis result includes the second fault cause of the first vehicle. The fault diagnosis agent module may determine, based on the second fault cause, a fault level corresponding to the second fault cause, and may obtain, from a database (or a data storage area) used to store a handling scheme corresponding to a fault cause, a handling scheme corresponding to the second fault cause. Then, the fault diagnosis agent module may generate the first fault handling report of the first vehicle based on the second fault cause, the fault level corresponding to the second fault cause, and the handling scheme corresponding to the second fault cause. Then, the fault diagnosis agent module may send the first fault handling report of the first vehicle to the first vehicle (or the user of the first vehicle or a manufacturer corresponding to the first vehicle). In some instances, the fault diagnosis agent module may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

For example, after obtaining the first information, the first fault diagnosis module may query, based on the first information, a database (or a data storage area) used to store data reported by the vehicle, to obtain data that is of the first vehicle and that corresponds to the first fault diagnosis module, and may analyze and process the data corresponding to the first fault diagnosis module, to obtain the second diagnosis result of the first vehicle.

For example, the first fault diagnosis module is a battery fault diagnosis module. In an example, when the first information includes the vehicle identifier (or the vehicle name) of the first vehicle, the battery fault diagnosis module may query, based on the vehicle identifier (or the vehicle name) of the first vehicle, the database (or the data storage area) used to store the data reported by the vehicle, to obtain historical battery data of the first vehicle. Then, the battery fault diagnosis module may analyze and process the historical battery data of the first vehicle, to obtain a second diagnosis result of the first vehicle. In another example, when the first information includes the vehicle identifier (or the vehicle name) of the first vehicle and the current time, the battery fault diagnosis module may query, based on the vehicle identifier (or the vehicle name) of the first vehicle and the current time, the database (or the data storage area) used to store the data reported by the vehicle, to obtain battery data of the first vehicle that is timestamped at the current time. Then, the battery fault diagnosis module may analyze and process the battery data of the first vehicle that is timestamped at the current time, to obtain a second diagnosis result of the first vehicle. In another example, when the first information includes the vehicle identifier (or the vehicle name) of the first vehicle and the fault occurrence time (or the fault occurrence time period), the database (or the data storage area) used to store the data reported by the vehicle may be queried, based on the vehicle identifier (or the vehicle name) of the first vehicle and the fault occurrence time (or the fault occurrence time period), to obtain battery data of the first vehicle that is timestamped at the fault occurrence time (or in the fault occurrence time period). Then, the battery fault diagnosis module may analyze and process the battery data of the first vehicle that is timestamped at the fault occurrence time (or in the fault occurrence time period), to obtain a second diagnosis result of the first vehicle. It should be understood that the foregoing content is merely examples for describing several possible examples in which the battery fault diagnosis module determines the second diagnosis result of the first vehicle. The battery fault diagnosis module may alternatively determine the second diagnosis result of the first vehicle in other possible examples. These examples are not enumerated one by one in this embodiment of this disclosure.

Implementation 2: When the vehicle fault diagnosis apparatus is the integrated unit of the first functional module (or the first compute device) and the fault diagnosis agent module (or the fault diagnosis agent module configured with the fault diagnosis model), after obtaining the first fault description data, the vehicle fault diagnosis apparatus may input the first fault description data into the fault diagnosis model to obtain the first diagnosis result. In some instances, for related descriptions of content included in the first diagnosis result in Implementation 2, refer to the related descriptions of the content included in the first diagnosis result in Implementation 1. Details are not described herein again. After obtaining the first diagnosis result, the vehicle fault diagnosis apparatus may perform, based on the first diagnosis result, the fault diagnosis operation corresponding to the first diagnosis result.

For example, the following describes, by using the following several possible examples, an implementation process in which the vehicle fault diagnosis apparatus performs, based on the first diagnosis result, the fault diagnosis operation corresponding to the first diagnosis result. In some instances, after obtaining the first diagnosis result, the vehicle fault diagnosis apparatus may identify the first diagnosis result, and determine whether the first diagnosis result includes information about a first fault diagnosis module. For example, the vehicle fault diagnosis apparatus may parse the first diagnosis result to obtain a parsed first diagnosis result.

Example 1: When the parsed first diagnosis result does not include the information about the first fault diagnosis module, the vehicle fault diagnosis apparatus may generate the first fault handling report of the first vehicle based on the first diagnosis result. For example, the first diagnosis result includes a first fault cause of the first vehicle. The vehicle fault diagnosis apparatus may determine, based on the first fault cause, a fault level corresponding to the first fault cause, and may obtain, from a database (or a data storage area) used to store a handling scheme corresponding to a fault cause, a handling scheme corresponding to the first fault cause. Then, the vehicle fault diagnosis apparatus may generate the first fault handling report of the first vehicle based on the first fault cause, the fault level corresponding to the first fault cause, and the handling scheme corresponding to the first fault cause. Then, the vehicle fault diagnosis apparatus may send the first fault handling report of the first vehicle to the first vehicle (or the user of the first vehicle or a manufacturer corresponding to the first vehicle). In some instances, the vehicle fault diagnosis apparatus may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

Example 2: When the parsed first diagnosis result includes the information about the first fault diagnosis module, based on the information about the first fault diagnosis module, the vehicle fault diagnosis apparatus may invoke the first fault diagnosis module (for example, send an invocation indication or an invocation instruction to the first fault diagnosis module), or send the first information to the first fault diagnosis module.

For example, the vehicle fault diagnosis apparatus sends the invocation instruction to the first fault diagnosis module. The vehicle fault diagnosis apparatus may generate the invocation instruction based on the obtained related information (for example, the vehicle name (or the vehicle identifier), the vehicle model and the vehicle series, the purchase time, or the fault occurrence time) of the first vehicle, and may send the invocation instruction to the first fault diagnosis module. The invocation instruction indicates to perform fault diagnosis on the first vehicle. For example, the invocation instruction may include the vehicle identifier (or the vehicle name) of the first vehicle, or the invocation instruction may include the vehicle identifier (or the vehicle name) of the first vehicle and current time, or the invocation instruction may include the vehicle identifier (or the vehicle name) of the first vehicle and the fault occurrence time (or the fault occurrence time period), or the invocation instruction may include the vehicle identifier (or the vehicle name) of the first vehicle, the current time, the fault occurrence time (or the fault occurrence time period), and the vehicle model and the vehicle series of the first vehicle. After obtaining the invocation instruction from the fault diagnosis agent module, the first fault diagnosis module may perform fault diagnosis on the first vehicle to obtain a second diagnosis result, and may send the second diagnosis result to the vehicle fault diagnosis apparatus. For example, the second diagnosis result may include a second fault cause of the first vehicle, or may not include the second fault cause of the first vehicle.

After obtaining the second diagnosis result from the first fault diagnosis module, the vehicle fault diagnosis apparatus may generate the first fault handling report of the first vehicle based on the second diagnosis result. For example, the second diagnosis result includes the second fault cause of the first vehicle. The vehicle fault diagnosis apparatus may determine, based on the second fault cause, a fault level corresponding to the second fault cause, and may obtain, from a database (or a data storage area) used to store a handling scheme corresponding to a fault cause, a handling scheme corresponding to the second fault cause. Then, the vehicle fault diagnosis apparatus may generate the first fault handling report of the first vehicle based on the second fault cause, the fault level corresponding to the second fault cause, and the handling scheme corresponding to the second fault cause. Then, the vehicle fault diagnosis apparatus may send the first fault handling report of the first vehicle to the first vehicle (or the user of the first vehicle or a manufacturer corresponding to the first vehicle). In some instances, the vehicle fault diagnosis apparatus may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

It should be understood that Implementation 1 and Implementation 2 are described for the fault diagnosis model being a trained AI model (for example, a trained generative AI model).

Implementation 3: When the vehicle fault diagnosis apparatus is the first functional module (or the first compute device), after obtaining the first fault description data (or the problem log), the vehicle fault diagnosis apparatus may input the first fault description data into the trained AI model to obtain one or more keywords. Then, the vehicle fault diagnosis apparatus may match, from the diagnosis tree knowledge base, at least one fault diagnosis tree corresponding to the one or more keywords. In some instances, after obtaining the one or more keywords, the vehicle fault diagnosis apparatus may alternatively send the one or more keywords to the fault diagnosis agent module. After obtaining the one or more keywords, the fault diagnosis agent module may match, from the diagnosis tree knowledge base, the at least one fault diagnosis tree corresponding to the one or more keywords. The at least one fault diagnosis tree may form a fault diagnosis tree group that adapts to the first fault description data. The fault diagnosis tree group is used to determine the first diagnosis result of the first vehicle. The diagnosis tree knowledge base may include a plurality of fault diagnosis trees.

It may be understood that, when matching no fault diagnosis tree corresponding to the one or more keywords in the diagnosis tree knowledge base, the vehicle fault diagnosis apparatus may construct, based on the one or more keywords and historical fault log information related to a same vehicle model and vehicle series that correspond to the first vehicle, a minimal problem fault diagnosis tree that matches the one or more keywords. Then, the vehicle fault diagnosis apparatus may update the constructed minimal problem fault diagnosis tree that matches the one or more keywords to the diagnosis tree knowledge base.

In some instances, after obtaining the fault diagnosis tree group, the vehicle fault diagnosis apparatus may obtain the historical fault log information related to the same vehicle model and vehicle series that correspond to the first vehicle, and a real-time vehicle condition log (for example, a running log of a component related to an audio module, a running log of a component related to a Bluetooth module, a running log of a power supply system module, and a log of in-vehicle environment perception information) currently uploaded by the first vehicle. Then, the vehicle fault diagnosis apparatus may determine the first diagnosis result based on the historical fault log information related to the same vehicle model and vehicle series, the real-time vehicle condition log currently uploaded by the first vehicle, and the fault diagnosis tree group. It should be understood that, after obtaining the real-time vehicle condition log currently uploaded by the first vehicle, the vehicle fault diagnosis apparatus may update the real-time vehicle condition log currently uploaded by the first vehicle to a vehicle condition log library. For example, the historical fault log information related to the same vehicle model and vehicle series that correspond to the first vehicle may be stored in the vehicle condition log library.

In this embodiment of this disclosure, the vehicle fault diagnosis apparatus may determine, based on the historical fault log information related to the same vehicle model and vehicle series that correspond to the first vehicle, a fault matching probability corresponding to the at least one fault diagnosis tree included in the fault diagnosis tree group. A higher fault matching probability indicates a higher probability that a fault diagnosis tree is in accordance with (or close to) a fault of the first vehicle. Then, the vehicle fault diagnosis apparatus may select a fault diagnosis tree with a highest fault matching probability, and determine the first diagnosis result of the first vehicle with reference to the real-time vehicle condition log currently uploaded by the first vehicle. In some instances, the vehicle fault diagnosis apparatus may alternatively determine the first diagnosis result of the first vehicle by combining the at least one fault diagnosis tree with the real-time vehicle condition log currently uploaded by the first vehicle.

For example, the first fault description data is “I do not know why there is continuous buzzing electric noise in my vehicle, and songs played through the Bluetooth connection to the mobile phone are intermittent” and the trained AI model is a trained generative AI model. The vehicle fault diagnosis apparatus inputs the first fault description data “I do not know why there is continuous buzzing electric noise in my vehicle, and songs played through the Bluetooth connection to the mobile phone are intermittent” into the trained generative AI model to obtain a plurality of keywords, for example, a keyword “abnormal sound” and a keyword “Bluetooth exception”. Subsequently, based on these keywords, the vehicle fault diagnosis apparatus matches a plurality of fault diagnosis trees, for example, a minimal problem fault tree for an audio system exception, a minimal problem fault tree for a Bluetooth exception, and a minimal problem fault tree for a power supply exception, in the diagnosis tree knowledge base. The plurality of fault diagnosis trees may form a fault diagnosis tree group that adapts to the first fault description data “I do not know why there is continuous buzzing electric noise in my vehicle, and songs played through the Bluetooth connection to the mobile phone are intermittent”. Then, the vehicle fault diagnosis apparatus may obtain the historical fault log information related to the same vehicle model and vehicle series that correspond to the first vehicle, and the real-time vehicle condition log currently uploaded by the first vehicle. Then, the vehicle fault diagnosis apparatus may determine, based on the historical fault log information related to the same vehicle model and vehicle series that correspond to the first vehicle, fault matching probabilities respectively corresponding to the plurality of fault diagnosis trees included in the fault diagnosis tree group. For example, a fault matching probability corresponding to the minimal problem fault tree for the audio system exception is a, a fault matching probability corresponding to the minimal problem fault tree for the Bluetooth exception is b, and a fault matching probability corresponding to the minimal problem fault tree for the power supply exception is c. It is assumed that the fault matching probability a corresponding to the minimal problem fault tree for the audio system exception is largest. The vehicle fault diagnosis apparatus may determine the first diagnosis result of the first vehicle based on the minimal problem fault tree for the audio system exception and the real-time vehicle condition log currently uploaded by the first vehicle. In some instances, the vehicle fault diagnosis apparatus may alternatively determine the first diagnosis result of the first vehicle by combining each of the plurality of fault diagnosis trees with the real-time vehicle condition log currently uploaded by the first vehicle.

The following describes a process of constructing the diagnosis tree knowledge base.

The vehicle fault diagnosis apparatus or a cloud server (which may alternatively be referred to as a vehicle-cloud server) may obtain a plurality of diagnosis tree knowledge bases through classification based on vehicle series and vehicle models, use a minimal problem (for example, unstable tire pressure, an audio-system sound exception, or an air conditioner heating failure) as a top event, and perform multi-level decomposition on the top event based on vehicle-related parts, to form several intermediate events, until the minimal problem is attributed to a specific part problem, so that a fault diagnosis tree for diagnosing the minimal problem is constructed. In this way, fault diagnosis trees for a plurality of minimal problems can be constructed. Then, the vehicle fault diagnosis apparatus or the cloud server may construct the diagnosis tree knowledge base based on the fault diagnosis trees for the plurality of minimal problems.

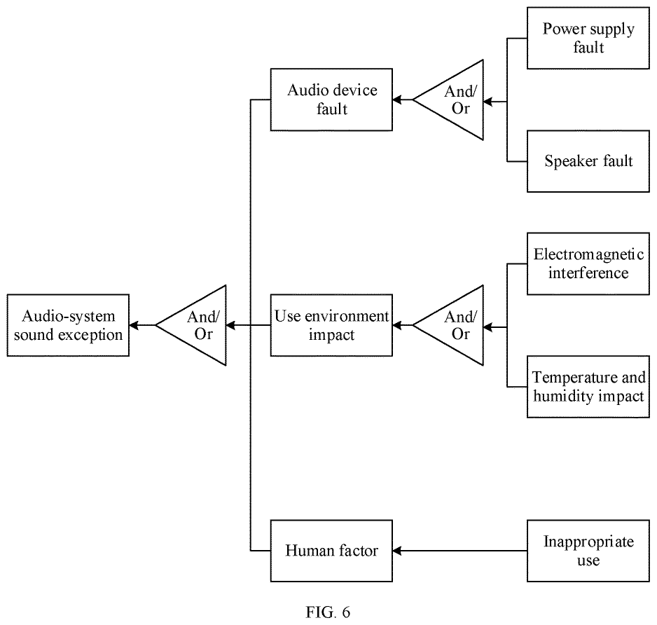

For example, a process of constructing the fault diagnosis tree for the minimal problem is described by using an example in which the minimal problem is the audio-system sound exception. As shown in FIG. 6, the vehicle fault diagnosis apparatus or the cloud server uses the audio-system sound exception as a top event, and decomposes the top event based on vehicle-related parts, to learn that sublevels of the audio-system sound exception are an audio device fault, use environment affect, and a human factor. Then, the vehicle fault diagnosis apparatus or the cloud server decomposes the audio device fault, to learn that sublevels of the audio device fault are a power supply fault and a speaker fault, decomposes the use environment impact, to learn that sublevels of the use environment impact are electromagnetic interference and temperature and humidity impact, and decomposes the human factor, to learn that a sublevel of the human factor is inappropriate use. In this way, the vehicle fault diagnosis apparatus or the cloud server may construct the minimal problem fault tree for the audio system exception shown in FIG. 6. It should be noted that “And (which may alternatively be referred to as and)/Or” in the leftmost part of FIG. 6 indicates that any one or more of the audio device fault, the use environment impact, or the human factor cause the audio-system sound exception; “And/Or” in the uppermost part of FIG. 6 indicates that any one or more of the power supply fault or the speaker fault cause the audio device fault; and “And/Or” in the middle part of FIG. 6 indicates that any one or more of the electromagnetic interference or the temperature and humidity impact cause the use environment impact.

In a possible implementation, in Implementation 3, the first diagnosis result of the first vehicle may be determined by the vehicle fault diagnosis apparatus. Then, the vehicle fault diagnosis apparatus may send the first diagnosis result to the fault diagnosis agent module. After receiving the first diagnosis result, the fault diagnosis agent module may perform, based on the first diagnosis result, the fault diagnosis operation corresponding to the first diagnosis result.

In another possible implementation, in Implementation 3, after obtaining the fault diagnosis tree group, the vehicle fault diagnosis apparatus may send the fault diagnosis tree group to the fault diagnosis agent module, and the fault diagnosis agent module determines the first diagnosis result of the first vehicle based on the fault diagnosis tree group. Then, the fault diagnosis agent module may perform, based on the first diagnosis result, the fault diagnosis operation corresponding to the first diagnosis result.

In another possible implementation, in Implementation 3, after obtaining the one or more keywords, the vehicle fault diagnosis apparatus may send the one or more keywords to the fault diagnosis agent module. After obtaining the one or more keywords, the fault diagnosis agent module may match, from the diagnosis tree knowledge base, the at least one fault diagnosis tree corresponding to the one or more keywords. The at least one fault diagnosis tree may form the fault diagnosis tree group that adapts to the first fault description data. Then, the fault diagnosis agent module may determine the first diagnosis result of the first vehicle based on the fault diagnosis tree group. Then, the fault diagnosis agent module may perform, based on the first diagnosis result, the fault diagnosis operation corresponding to the first diagnosis result.

In some instances, for an implementation process in which the fault diagnosis agent module performs the fault diagnosis operation corresponding to the first diagnosis result in Implementation 3, refer to the implementation process in which the fault diagnosis agent module performs the fault diagnosis operation corresponding to the first diagnosis result in Implementation 1. Details are not described herein again.

Implementation 4: When the vehicle fault diagnosis apparatus is the integrated unit of the first functional module (or the first compute device) and the fault diagnosis agent module, after obtaining the first fault description data (or the problem log), the vehicle fault diagnosis apparatus may input the first fault description data into the fault diagnosis model to obtain the trained AI model to obtain one or more keywords. Then, the vehicle fault diagnosis apparatus may match, from the diagnosis tree knowledge base, at least one fault diagnosis tree corresponding to the one or more keywords. The at least one fault diagnosis tree may form a fault diagnosis tree group that adapts to the first fault description data. The fault diagnosis tree group is used to determine the first diagnosis result of the first vehicle. The diagnosis tree knowledge base may include a plurality of fault diagnosis trees. In some instances, for a process of constructing the diagnosis tree knowledge base in Implementation 4, refer to the process of constructing the diagnosis tree knowledge base in Implementation 3. Details are not described herein again.

In some instances, after obtaining the fault diagnosis tree group, the vehicle fault diagnosis apparatus may determine the first diagnosis result of the first vehicle based on the fault diagnosis tree group. For an implementation process in which the vehicle fault diagnosis apparatus determines the first diagnosis result of the first vehicle based on the fault diagnosis tree group in Implementation 4, refer to the implementation process in which the vehicle fault diagnosis apparatus determines the first diagnosis result of the first vehicle in Implementation 3. Details are not described herein again.

In addition, after obtaining the first diagnosis result of the first vehicle, the vehicle fault diagnosis apparatus may perform, based on the first diagnosis result, the fault diagnosis operation corresponding to the first diagnosis result. For an implementation process in which the vehicle fault diagnosis apparatus performs the fault diagnosis operation corresponding to the first diagnosis result in Implementation 4, refer to the implementation process in which the vehicle fault diagnosis apparatus performs the fault diagnosis operation corresponding to the first diagnosis result in Implementation 2. Details are not described herein again.

It should be understood that Implementation 3 and Implementation 4 are described for the fault diagnosis model being the combination of the diagnosis tree knowledge base and the trained AI model (for example, the trained generative AI model).

It can be learned from step 301 and step 302 that the first fault description data of the first vehicle (which may alternatively be understood as a fault symptom description of the vehicle) is analyzed by using the fault diagnosis model, so that a corresponding diagnosis result (for example, the first diagnosis result) can be obtained in time and effectively. In this way, manual vehicle fault diagnosis can be replaced. This helps reduce duration of vehicle fault diagnosis, thereby improving efficiency of vehicle fault diagnosis. It should be understood that the fault diagnosis model is also obtained by learning vehicle fault diagnosis knowledge (for example, the fault training sample) based on a learning capability of the fault diagnosis model. Therefore, the fault diagnosis model may be used to replace manual vehicle fault diagnosis, and the vehicle fault may be analyzed by using the multimodal understanding capability (for example, input data of different data types may be perceived) of the fault diagnosis model, so that the vehicle fault can be effectively determined.

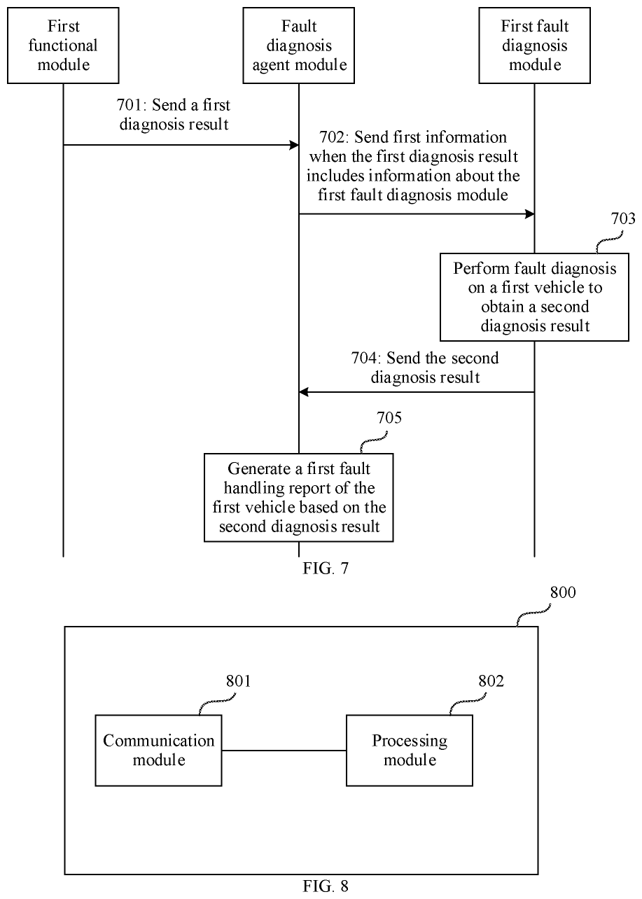

FIG. 7 shows an example of a schematic flowchart of another vehicle fault diagnosis method according to an embodiment of this disclosure. The method procedure may be implemented through data exchange between a plurality of vehicle fault diagnosis apparatuses (for example, a first vehicle fault diagnosis apparatus and a second vehicle fault diagnosis apparatus) and a fault diagnosis module (for example, a first fault diagnosis module). In some instances, the first vehicle fault diagnosis apparatus may be a first functional module (or a first compute device) or an element (for example, a chip, a chip system, or a circuit) that can support the first functional module (or the first compute device) in implementing a function for the method. The second vehicle fault diagnosis apparatus may be a fault diagnosis agent module or an element (for example, a chip, a chip system, or a circuit) that can support the fault diagnosis agent module in implementing a function for the method. To facilitate description of technical solutions provided in this embodiment of this disclosure, the following describes, by using an example in which the first vehicle fault diagnosis apparatus is the first functional module and the second vehicle fault diagnosis apparatus is the fault diagnosis agent module, a procedure of implementing the vehicle fault diagnosis method through data exchange between the first vehicle fault diagnosis apparatus, the second vehicle fault diagnosis apparatus, and the fault diagnosis module. As shown in FIG. 7, the method includes steps 701 to 705.

Step 701: The first functional module sends a first diagnosis result to the fault diagnosis agent module. The fault diagnosis agent module receives the first diagnosis result.

In some instances, the first diagnosis result may indicate the fault diagnosis agent module to perform a fault diagnosis operation corresponding to the first diagnosis result.

In some instances, for an implementation process in which the first functional module determines the first diagnosis result, refer to the implementation process in which the first functional module determines the first diagnosis result in the vehicle fault diagnosis method shown in FIG. 3. Details are not described herein again.

Step 702: When the first diagnosis result includes information about the first fault diagnosis module, the fault diagnosis agent module sends first information to the first fault diagnosis module. The first fault diagnosis module receives the first information.

The first information indicates to perform fault diagnosis on a first vehicle. For example, the first information may include information about the first vehicle. For example, the information about the first vehicle may include but is not limited to a vehicle identifier (or a vehicle name) of the first vehicle, a vehicle model and a vehicle series of the first vehicle, time (or a time period) at (or in) which the first vehicle has a fault, or time at which a user submits a fault symptom.

In some instances, for an implementation process of step 702, refer to the implementation process provided in Example 2 in Implementation 1 of step 302. Details are not described herein again.

It may be understood that, when the first diagnosis result does not include the information about the first fault diagnosis module, for a corresponding implementation process in which the fault diagnosis agent module performs the fault diagnosis operation corresponding to the first diagnosis result, refer to the implementation process provided in Example 1 in Implementation 1 of step 302. Details are not described herein again.

Step 703: The first fault diagnosis module performs fault diagnosis on the first vehicle to obtain a second diagnosis result.

In this embodiment of this disclosure, after obtaining the first information from the fault diagnosis agent module, the first fault diagnosis module may perform fault diagnosis on the first vehicle to obtain the second diagnosis result. For example, the second diagnosis result may include a second fault cause of the first vehicle, or may not include the second fault cause of the first vehicle.

For example, after obtaining the first information, the first fault diagnosis module may query, based on the first information, a database (or a data storage area) used to store data reported by the vehicle, to obtain data that is of the first vehicle and that corresponds to the first fault diagnosis module, and may analyze and process the data corresponding to the first fault diagnosis module, to obtain the second diagnosis result of the first vehicle.

For example, the first fault diagnosis module is a motor fault diagnosis module. In an example, when the first information includes the vehicle identifier (or the vehicle name) of the first vehicle, the motor fault diagnosis module may query, based on the vehicle identifier (or the vehicle name) of the first vehicle, the database (or the data storage area) used to store the data reported by the vehicle, to obtain historical motor data (for example, historical motor CAN signal data) of the first vehicle. Then, the motor fault diagnosis module may analyze and process the historical motor data of the first vehicle, to obtain a second diagnosis result of the first vehicle. In another example, when the first information includes the vehicle identifier (or the vehicle name) of the first vehicle and current time, the motor fault diagnosis module may query, based on the vehicle identifier (or the vehicle name) of the first vehicle and the current time, the database (or the data storage area) used to store the data reported by the vehicle, to obtain motor data (for example, motor CAN signal data) of the first vehicle that is timestamped at the current time. Then, the motor fault diagnosis module may analyze and process the motor data of the first vehicle that is timestamped at the current time, to obtain a second diagnosis result of the first vehicle. In another example, when the first information includes the vehicle identifier (or the vehicle name) of the first vehicle and the fault occurrence time (or the fault occurrence time period), the database (or the data storage area) used to store the data reported by the vehicle may be queried, based on the vehicle identifier (or the vehicle name) of the first vehicle and the fault occurrence time (or the fault occurrence time period), to obtain motor data of the first vehicle that is timestamped at the fault occurrence time (or in the fault occurrence time period). Then, the motor fault diagnosis module may analyze and process the motor data of the first vehicle that is timestamped at the fault occurrence time (or in the fault occurrence time period), to obtain a second diagnosis result of the first vehicle. It should be understood that the foregoing content is merely examples for describing several possible examples in which the motor fault diagnosis module determines the second diagnosis result of the first vehicle. The motor fault diagnosis module may alternatively determine the second diagnosis result of the first vehicle in other possible examples. These examples are not enumerated one by one in this embodiment of this disclosure.

Step 704: The first fault diagnosis module sends the second diagnosis result to the fault diagnosis agent module. The fault diagnosis agent module receives the second diagnosis result.

Step 705: The fault diagnosis agent module generates a first fault handling report of the first vehicle based on the second fault diagnosis result.

In this embodiment of this disclosure, after obtaining the second diagnosis result, the fault diagnosis agent module may generate the first fault handling report of the first vehicle based on the second diagnosis result.

In an example, when the second diagnosis result includes the second fault cause of the first vehicle, the fault diagnosis agent module may determine, based on the second fault cause, a fault level corresponding to the second fault cause, and may obtain, from a database (or a data storage area) used to store a handling scheme corresponding to a fault cause, a handling scheme corresponding to the second fault cause. Then, the fault diagnosis agent module may generate the first fault handling report of the first vehicle based on the second fault cause, the fault level corresponding to the second fault cause, and the handling scheme corresponding to the second fault cause. Then, the fault diagnosis agent module may send the first fault handling report of the first vehicle to the first vehicle (or the user of the first vehicle or a manufacturer corresponding to the first vehicle). In some instances, the fault diagnosis agent module may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

In another example, when the second diagnosis result does not include the second fault cause of the first vehicle, the fault diagnosis agent module may generate the first fault handling report of the first vehicle based on the first vehicle having no fault. A fault cause included in the first fault handling report is that the first vehicle has no fault. Then, the fault diagnosis agent module may send the first fault handling report of the first vehicle to the first vehicle (or the user of the first vehicle or a manufacturer corresponding to the first vehicle). In some instances, the fault diagnosis agent module may further submit a diagnosis record of the first vehicle to the manufacturer corresponding to the first vehicle, so that the manufacturer correspondingly repairs the first vehicle. In this embodiment of this disclosure, the user of the first vehicle may alternatively perform a corresponding after-sales repair reservation operation in time based on the first fault handling report.

It can be learned from step 701 to step 705 that, when the first diagnosis result includes the information about the first fault diagnosis module, the fault diagnosis agent module sends, to a corresponding fault diagnosis module (for example, the first fault diagnosis module), the first information indicating to perform fault diagnosis on the first vehicle, to further determine the vehicle fault via the corresponding fault diagnosis module, thereby effectively locating the vehicle fault. In this way, in the method, the fault diagnosis agent module is used, so that a fault diagnosis model can have a capability of invoking a corresponding fault diagnosis module. This can implement a fully automatic operation of vehicle fault analysis, vehicle fault diagnosis, and vehicle fault determining, and help greatly improve efficiency of vehicle fault diagnosis (or vehicle fault locating or vehicle fault detection).

It should be noted that, in the descriptions of this disclosure, “at least one” means one or more, and “a plurality of” means two or more. The term “and/or” describes an association relationship between associated objects, and indicates that three relationships may exist. For example, A and/or B may indicate the following cases: Only A exists, both A and B exist, and only B exists, where A and B may be singular or plural. The character “/” generally indicates an “or” relationship between associated objects. “At least one of the following items (pieces)” or a similar expression thereof means any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first”, “second”, and “third” mentioned in embodiments of this disclosure are intended to distinguish between a plurality of objects, and are not intended to limit a sequence, a time sequence, priorities, or importance degrees of the plurality of objects. In addition, the terms “include”, “contain”, and “have” and variations thereof that appear in this disclosure all mean “including but not limited to”, unless otherwise emphasized in another manner.

In addition, it should be noted that each step in the foregoing embodiments may be performed by a corresponding device, or may be performed by a component like a chip, a processor, or a chip system in the device. This is not limited in embodiments of this disclosure. The foregoing embodiments are described only by using an example in which each step is performed by the corresponding device.

It should be noted that, in the foregoing embodiments, a part of steps may be selected for implementation, or an order of steps in the figure may be adjusted for implementation. This is not limited in this disclosure. It should be understood that performing the part of steps in the figure, adjusting an order of the steps, or combining the two manners for an implementation shall fall within the protection scope of this disclosure.

It may be understood that, to implement functions in the foregoing embodiments, devices in the foregoing embodiments include corresponding hardware structures and/or software modules for performing the functions. A person skilled in the art should be easily aware that, in combination with the units and the method steps in the examples described in embodiments disclosed in this disclosure, this disclosure can be implemented by hardware or a combination of the hardware and computer software. Whether a function is performed by hardware or hardware driven by computer software depends on particular application scenarios and design constraints of the technical solutions.

It should be noted that the “step” in embodiments of this disclosure is merely an example, is a representation method used to better understand embodiments, and does not constitute a substantive limitation on execution of the solutions in this disclosure. For example, the “step” may also be understood as a “feature”. In addition, the step does not constitute any limitation on an execution order of the solutions in this disclosure, and a new technical solution formed through an operation, for example, step order change, step combination, or step splitting, performed on this basis without affecting implementation of the overall solutions also falls within the scope disclosed in this disclosure.

Based on a same concept, an embodiment of this disclosure further provides a possible vehicle fault diagnosis apparatus. The vehicle fault diagnosis apparatus is applicable to the application scenario shown in FIG. 1. In an example, the vehicle fault diagnosis apparatus may be the vehicle fault diagnosis apparatus included in the vehicle fault diagnosis system 200 shown in FIG. 1, or may be a functional module (for example, a plug-in, a component, or a chip) disposed in the vehicle fault diagnosis apparatus included in the vehicle fault diagnosis system 200 shown in FIG. 1. The functional module (which may alternatively be referred to as a functional component or a functional element) has a function of implementing a vehicle fault diagnosis method. In another example, the vehicle fault diagnosis apparatus may alternatively be another device (for example, another compute device or a diagnosis unit) that has a vehicle fault diagnosis function in the vehicle fault diagnosis system 200 shown in FIG. 1, or may be a functional module (for example, a plug-in, a component, or a chip) disposed in the another device that has the vehicle fault diagnosis function in the vehicle fault diagnosis system 200 shown in FIG. 1. In some instances, the vehicle fault diagnosis apparatus may be configured to implement the vehicle fault diagnosis method provided in the foregoing embodiments, or the module (for example, the chip) of the vehicle fault diagnosis apparatus may be configured to implement the vehicle fault diagnosis method provided in the foregoing embodiments, and therefore can also achieve beneficial effect of the foregoing embodiments. For example, the vehicle fault diagnosis apparatus is the chip disposed in the vehicle fault diagnosis apparatus (or the vehicle fault diagnosis system 200). When the vehicle fault diagnosis apparatus is the chip, the vehicle fault diagnosis apparatus includes a transceiver and a processor, and does not include a memory. The transceiver exists as an input/output interface, and the input/output interface is used by the chip to implement receiving and sending of the vehicle fault diagnosis apparatus. The input/output interface may include an input interface and/or an output interface. The input interface may implement receiving of the vehicle fault diagnosis apparatus, and the output interface may be configured to implement sending of the vehicle fault diagnosis apparatus. The processor is configured to: read and execute a corresponding computer program or corresponding instructions, so that a corresponding function of the vehicle fault diagnosis apparatus is implemented. In some instances, when the chip implements the corresponding function of the vehicle fault diagnosis apparatus in the foregoing embodiments, the input/output interface may implement receiving and sending operations performed by the vehicle fault diagnosis apparatus in the foregoing embodiments, and the processor may implement an operation other than the receiving and sending operations performed by the vehicle fault diagnosis apparatus in the foregoing embodiments. For related descriptions, refer to the related descriptions in the method embodiment shown in FIG. 3 or FIG. 7. Details are not described herein again.

As shown in FIG. 8, a vehicle fault diagnosis apparatus 800 includes a communication module 801 (which may alternatively be referred to as a transceiver module, a transceiver unit, or a communication unit, and is configured to: send and receive data) and a processing module 802.

In some instances, the communication module 801 may include a receiving module and/or a sending module. The receiving module may be used by the vehicle fault diagnosis apparatus 800 to receive a signal (information, data, or the like). The sending module may be used by the vehicle fault diagnosis apparatus 800 to send a signal (information, data, or the like). The sending module may send the signal (the information, the data, or the like) under control of the processing module 802. The receiving module may receive the signal (the information, the data, or the like) under control of the processing module 802.

When the vehicle fault diagnosis apparatus 800 is configured to implement functions of the vehicle fault diagnosis apparatus (for example, the first functional module or the integrated module of the first functional module and the fault diagnosis agent module) in the method embodiment shown in FIG. 3, the communication module 801 is configured to obtain first fault description data of a first vehicle. The processing module 802 is configured to input the first fault description data into a fault diagnosis model to obtain a first diagnosis result. The fault diagnosis model may be used to describe a correspondence between fault description data of a vehicle and a diagnosis result, and the first diagnosis result indicates the fault diagnosis agent module to perform a fault diagnosis operation corresponding to the first diagnosis result.

When the vehicle fault diagnosis apparatus 800 is configured to implement functions of the vehicle fault diagnosis apparatus (for example, the fault diagnosis agent module or the integrated module of the first functional module and the fault diagnosis agent module) in the foregoing method embodiment, the communication module 801 is configured to receive a first diagnosis result. The first diagnosis result is associated with first fault description data of a first vehicle and a fault diagnosis model, the fault diagnosis model may be used to describe a correspondence between fault description data of a vehicle and a diagnosis result, and the first diagnosis result may indicate the fault diagnosis agent module to perform a fault diagnosis operation corresponding to the first diagnosis result. The processing module 802 is configured to perform, based on the first diagnosis result, the fault diagnosis operation corresponding to the first diagnosis result.

When the vehicle fault diagnosis apparatus 800 is configured to implement functions of the first functional module in the method embodiment shown in FIG. 7, the communication module 801 is configured to send a first diagnosis result to a fault diagnosis agent module. In some instances, the first diagnosis result indicates the fault diagnosis agent module to perform a fault diagnosis operation corresponding to the first diagnosis result. In some instances, the communication module 801 is further configured to obtain first fault description data of a first vehicle. The processing module 802 is configured to determine the first diagnosis result, for example, configured to input the first fault description data into a fault diagnosis model to obtain the first diagnosis result. The fault diagnosis model may be used to describe a correspondence between fault description data of a vehicle and a diagnosis result.

When the vehicle fault diagnosis apparatus 800 is configured to implement functions of the fault diagnosis agent module in the method embodiment shown in FIG. 7, the communication module 801 is configured to receive a first diagnosis result from a first functional module. In some instances, the first diagnosis result indicates the fault diagnosis agent module to perform a fault diagnosis operation corresponding to the first diagnosis result. The communication module 801 is further configured to: when the first diagnosis result includes information about a first fault diagnosis module, send first information to the first fault diagnosis module. In some instances, the first information may indicate to perform fault diagnosis on a first vehicle, and the first information may include information about the first vehicle. The communication module 801 is further configured to receive a second diagnosis result from the first fault diagnosis module. The processing module 802 is further configured to generate a first fault handling report of the first vehicle based on the second fault diagnosis result. The processing module 802 is further configured to: when the first diagnosis result includes the information about the first fault diagnosis module, generate the first fault handling report of the first vehicle based on the first diagnosis result. The communication module 801 is further configured to send the first fault handling report of the first vehicle to the first vehicle (or a user of the first vehicle or a manufacturer corresponding to the first vehicle).

For more detailed descriptions of the communication module 801 and the processing module 802, refer to the related descriptions of the vehicle fault diagnosis apparatus in the method embodiment shown in FIG. 2. Details are not described herein again.

It should be understood that, in this embodiment of this disclosure, the communication module 801 may be implemented by a transceiver or a transceiver-related circuit component, and the processing module 802 may be implemented by a processor or a processor-related circuit component.

It should be noted that, in this embodiment of this disclosure, division into the modules is an example, is merely logical function division, and may be other division during an implementation. In addition, functional units in embodiments of this disclosure may be integrated into one processing unit, or each of the units may exist alone physically, or two or more units may be integrated into one unit. The integrated unit may be implemented in a form of hardware, or may be implemented in a form of a software functional unit.

When being implemented in the form of the software functional unit and sold or used as an independent product, the integrated unit may be stored in a computer-readable storage medium. Based on such an understanding, the technical solutions of this disclosure essentially, or the part contributing to an example technology, or all or some of the technical solutions may be implemented in a form of a software product. The computer software product is stored in a storage medium and includes several instructions for instructing a computer device (which may be a personal computer, a server, or the like) or a processor to perform all or some of the steps of the methods described in embodiments of this disclosure. The storage medium includes any medium that can store program code, for example, a universal serial bus (USB) flash drive, a removable hard disk, a read-only memory (ROM), a random-access memory (RAM), a magnetic disk, or an optical disc.

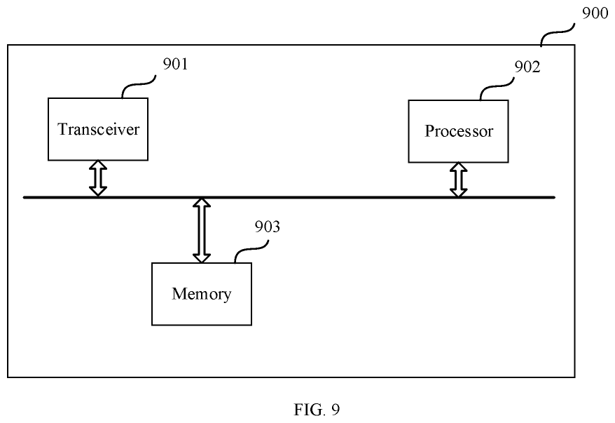

Based on a same concept, an embodiment of this disclosure further provides a possible vehicle fault diagnosis apparatus. The vehicle fault diagnosis apparatus is applicable to the application scenario shown in FIG. 1. The vehicle fault diagnosis apparatus is configured to implement technical solutions of the vehicle fault diagnosis apparatus in the method embodiment shown in FIG. 3 or FIG. 7, and therefore can also achieve beneficial effect of the vehicle fault diagnosis apparatus in the method embodiment shown in FIG. 3 or FIG. 7. As shown in FIG. 9, a vehicle fault diagnosis apparatus 900 includes a transceiver 901 and a processor 902. In some instances, the vehicle fault diagnosis apparatus 900 further includes a memory 903. The transceiver 901, the processor 902, and the memory 903 are connected to each other. When the vehicle fault diagnosis apparatus 900 is configured to implement the technical solutions of the vehicle fault diagnosis apparatus provided in the foregoing embodiments, the transceiver 901 may be configured to implement functions of the communication module 801, and the processor 902 is configured to implement functions of the processing module 802.

In some instances, the transceiver 901, the processor 902, and the memory 903 are connected to each other through a bus 904. The bus 904 may be a Peripheral Component Interconnect (PCI) bus, an Extended Industry Standard Architecture (EISA) bus, or the like. The bus may be classified into an address bus, a data bus, a control bus, and the like. For ease of representation, only one bold line is used for representation in FIG. 9, but this does not mean that there is only one bus or only one type of bus.

The transceiver 901 is configured to: receive and send data. For example, when the vehicle fault diagnosis apparatus 900 is a first functional module that has a function for implementing the method, the transceiver 901 may be configured to communicate with a data preprocessing system or another device (for example, a fault diagnosis agent module or a data storage system). In an example, the transceiver may be a transceiver apparatus integrated with data receiving and sending functions. In another example, the transceiver may alternatively include a transmitter and a receiver. The transmitter is configured to send the data, and the receiver is configured to receive the data.

In some instances, the transceiver 901 may include a transmitter and/or a receiver. The transmitter is configured to send a signal, a message, information, data, or the like. The receiver is configured to receive a signal, a message, information, data, or the like. For example, the transmitter sends the signal, the message, the information, or the data under control of the processor 902, and the receiver receives the signal, the message, the information, or the data under control of the processor 902.

For functions of the processor 902, refer to the descriptions of the corresponding functions of the vehicle fault diagnosis apparatus in the method embodiment shown in FIG. 3 or FIG. 7. Details are not described herein again. The processor 902 may be a central processing unit (CPU), a network processor (NP), a combination of the CPU and the NP, or the like. The processor 902 may further include a hardware chip. The hardware chip may be an ASIC, a PLD, or a combination thereof. The PLD may be a CPLD, an FPGA, a GAL, or any combination thereof. The processor 902 may implement the foregoing functions by hardware or by hardware executing corresponding software.

The memory 903 may include a volatile memory, for example, a RAM, and may further include a non-volatile memory, for example, at least one magnetic disk memory.

The memory 903 stores executable program code. The processor 902 executes the executable program code to separately implement the functions of the foregoing vehicle fault diagnosis apparatus (for example, the communication module and the processing module), to implement the vehicle fault diagnosis method provided in embodiments of this disclosure. In other words, the memory 903 stores computer program instructions used to perform the vehicle fault diagnosis method provided in embodiments of this disclosure.

Alternatively, the memory 903 stores executable code. The processor 902 executes the executable code to implement the functions of the foregoing vehicle fault diagnosis apparatus (for example, the communication module and the processing module), to implement the vehicle fault diagnosis method provided in embodiments of this disclosure. In other words, the memory 903 stores computer program instructions used to perform the vehicle fault diagnosis method provided in embodiments of this disclosure.

Based on a same concept, an embodiment of this disclosure further provides a computer program product. The computer program product includes a computer program or instructions. When the computer program or the instructions are run on a computer, the computer is enabled to perform the method provided in the foregoing embodiments.

Based on a same concept, an embodiment of this disclosure further provides a computer-readable storage medium. The computer-readable storage medium stores a computer program or instructions. When the computer program or the instructions are executed by a computer, the computer is enabled to perform the method provided in the foregoing embodiments.

The storage medium may be any usable medium that can be accessed by a computer. By way of example and not limitation, the computer-readable storage medium may include a RAM, a ROM, an electrically erasable programmable ROM (EEPROM), a compact disc ROM (CD-ROM), or another optical disc storage or disk storage medium, or another magnetic storage device, or any other medium that can carry or store expected program code in a form of an instruction or a data structure and can be accessed by a computer.

Based on a same concept, an embodiment of this disclosure further provides a chip. The chip may include a processor, and may further include a memory (or the chip is coupled to the memory). The chip executes program instructions in the memory, to perform the method provided in the foregoing embodiments. “Coupling” means that two components are directly or indirectly combined with each other. For example, coupling may mean that the two components are electrically connected to each other.

Based on a same concept, an embodiment of this disclosure further provides a chip system. The chip system includes a processor configured to support a computer apparatus in implementing functions of the vehicle fault diagnosis apparatus, the vehicle fault diagnosis system (for example, the data storage system, the data preprocessing system, or the diagnosis result feedback system), or the fault diagnosis module in the foregoing embodiments. In a possible design, the chip system further includes a memory. The memory is configured to store a program and data that are for the computer apparatus. The chip system may include a chip, or may include the chip and another discrete device.

The methods provided in embodiments of this disclosure may be all or partially implemented by software, hardware, firmware, or any combination thereof. When being implemented by the software, the methods may be all or partially implemented in a form of a computer program product. The computer program product includes one or more computer instructions. When the computer instruction is loaded and executed on a computer, the procedure or the functions according to embodiments of this disclosure are all or partially generated. The computer may be a general-purpose computer, a dedicated computer, a computer network, or another programmable apparatus. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium that can be accessed by a computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

Steps of the methods described in embodiments of this disclosure may be directly embedded into hardware, a software unit executed by a processor, or a combination thereof. The software unit may be stored in a RAM, a ROM, an EEPROM, a register, a hard disk drive, a removable magnetic disk, a CD-ROM, or a storage medium of any other form in the art. For example, the storage medium may be connected to the processor, so that the processor may read information from the storage medium and write information to the storage medium. In some instances, the storage medium may alternatively be integrated into the processor. The processor and the storage medium may be disposed in an ASIC.

This disclosure is described with reference to the flowcharts and/or block diagrams of the method, the device (system), and the computer program product according to this disclosure. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus configured to implement a specified function in one or more procedures in the flowcharts and/or a specified function in one or more blocks in the block diagrams.

These computer program instructions may alternatively be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specified function in one or more procedures in the flowcharts and/or a specified function in one or more blocks in the block diagrams.

Clearly, a person skilled in the art can make various modifications and variations to this disclosure without departing from the spirit and scope of this disclosure. In this case, this disclosure is also intended to cover these modifications and variations of this disclosure provided that they fall within the scope of the claims of this disclosure and equivalent technologies thereof.

1. A method comprising:
obtaining first fault description data of a first vehicle;
inputting the first fault description data into a fault diagnosis model to obtain a first diagnosis result, wherein the fault diagnosis model describes correspondences between fault description data and diagnosis results, and wherein the first diagnosis result indicates to a fault diagnosis agent to perform a fault diagnosis operation corresponding to the first diagnosis result; and
performing, based on the first diagnosis result, the fault diagnosis operation.

2. The method of claim 1, further comprising:
generating a first fault handling report based on the first diagnosis result; and
feeding back the first fault handling report to the first vehicle.

3. The method of claim 1, further comprising determining, by the fault diagnosis model, the first diagnosis result based on historical fault log information related to a vehicle model and a vehicle series of the first vehicle, a real-time vehicle condition log from the first vehicle, and a fault diagnosis tree group.

4. The method of claim 2, wherein generating the first fault handling report comprises:
sending first information to a first fault diagnosis system when the first diagnosis result comprises second information about the first fault diagnosis system, wherein the first information is about the first vehicle and indicates to perform fault diagnosis on the first vehicle;
obtaining a second diagnosis result from the first fault diagnosis system; and
generating the first fault handling report based on the second diagnosis result.

5. The method of claim 1, further comprising performing format conversion on second fault description data of the first vehicle to obtain the first fault description data, and wherein the second fault description data is based on user input.

6. The method of claim 1, wherein the fault diagnosis model is based on training a generative artificial intelligence (AI) model using a fault training sample comprising fault description data and a fault cause.

7. The method of claim 6, wherein the generative AI model is a large multimodal model.

8. The method of claim 3, further comprising determining, based on the historical fault log information, a fault matching probability corresponding to at least one fault diagnosis tree in the fault diagnosis tree group.

9. A method comprising:
receiving a first diagnosis result, wherein the first diagnosis result is associated with first fault description data of a first vehicle and a fault diagnosis model, wherein the fault diagnosis model describes correspondences between second fault description data of a second vehicle and second diagnosis results, and wherein the first diagnosis result indicates to a fault diagnosis agent system to perform a fault diagnosis operation corresponding to the first diagnosis result; and
performing, based on the first diagnosis result, the fault diagnosis operation.

10. The method of claim 9, wherein performing the fault diagnosis operation comprises generating a first fault handling report based on the first diagnosis result.

11. The method of claim 9, wherein when the first diagnosis result comprises second information about a first fault diagnosis system, the method further comprises:
sending first information to the first fault diagnosis system, wherein the first information is about the first vehicle and indicates to perform fault diagnosis on the first vehicle; and
obtaining a third diagnosis result from the first fault diagnosis system, wherein the third diagnosis result is for generating the first fault handling report.

12. The method of claim 9, wherein the first diagnosis result comprises a first fault cause of the first vehicle, and wherein the method further comprises:
determining, based on the first fault cause, a fault level corresponding to the first fault cause; and
obtaining, from a database for storing a first handling scheme corresponding to a second fault cause, a second handling scheme corresponding to the first fault cause.

13. The method of claim 9, wherein the first fault description data is from format conversion on third fault description data of the first vehicle, and wherein the third fault description data is from user input.

14. The method of claim 9, wherein the fault diagnosis model is from training a generative artificial intelligence (AI) model based on a fault training sample comprising fault description data and a fault cause.

15. The method of claim 14, wherein the generative AI model is a large multimodal model.

16. The method of claim 10, wherein the first fault handling report comprises at least one of a fault cause, a fault level, or a handling scheme corresponding to the fault cause.

17. A system, comprising:
a storage configured to store a program; and
a processor coupled to the storage and configured to execute the program to enable a first device to:
obtain first fault description data of a first vehicle;
input the first fault description data into a fault diagnosis model to obtain a first diagnosis result, wherein the fault diagnosis model describes correspondences between fault description data and diagnosis results, and wherein the first diagnosis result indicates to a fault diagnosis agent to perform a fault diagnosis operation corresponding to the first diagnosis result; and
perform, based on the first diagnosis result, the fault diagnosis operation.

18. The system of claim 17, wherein the processor is further configured to execute the program to further enable the first device to provide a fault description interface to prompt a user of the first vehicle to input a fault diagnosis requirement comprising second fault description data.

19. The system of claim 18, further comprising at least one of:
a data storage system configured to store at least one of first fault description data, the second fault description data, the first diagnosis result, a second diagnosis result, or a first fault handling report;
a data preprocessing system configured to preprocess the second fault description data; or
a diagnosis result feedback system configured to feed back the first fault handling report to the first vehicle.

20. The system of claim 17, wherein the fault diagnosis model is based on training a generative artificial intelligence (AI) model using a fault training sample comprising fault description data and a fault cause.
